(19) United States
(12) Patent Application Publication
(10) Pub. No.: US 2026/0371298 A1
(43) Pub. Date: Nov. 19, 2026

(54) ENERGY EFFICIENT POSITIONING PROCEDURES

(71) Applicant: QUALCOMM Incorporated, San Diego, CA (US)

(72) Inventors: Satyam GABA, San Diego, CA (US); Ananya AGRAWAL, San Diego, CA (US); Varun Amar REDDY, San Diego, CA (US); Marko ANGJELICHINOSKI, San Diego, CA (US)

(21) Appl. No.: 19/209,657

(22) Filed: May 15, 2025

(51) Int. Cl. H04W 64/00; H04W 8/22; H04W 52/02

(52) U.S. Cl. CPC H04W 64/00; H04W 8/22; H04W 52/028

(57) ABSTRACT

Methods, systems, and devices for wireless communications are described. A wireless device may output, to a server, positioning information associated with the wireless device within an environment, the positioning information being based on a combination of radio frequency (RF) data and visual data that are both associated with the environment. The wireless device may further communicate with the server in accordance with the positioning information. A wireless device may also output, to a server, a request for a first subset of mapping information associated with an environment, the request including an indication of positioning information of the wireless device. The wireless device may obtain an indication of the first subset of mapping information and output positioning information reports to the server accordingly. Further, the wireless device may obtain an indication of a second subset of mapping information based on at least one positioning information report.

### FIELD OF TECHNOLOGY

The following relates to wireless communications, including energy efficient positioning procedures.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a wireless device is described. The method may include outputting, to a server, positioning information associated with the wireless device within an environment, the positioning information being based on a combination of radio frequency (RF) data and visual data, where the RF data and the visual data are associated with the environment and communicating with the server in accordance with the positioning information that is based on the combination of both the RF data and the visual data.

A wireless device for wireless communications is described. The wireless device may include one or more memories storing processor executable code, and one or more processors coupled with the one or more memories. The one or more processors may individually or collectively be operable to execute the code to cause the wireless device to output, to a server, positioning information associated with the wireless device within an environment, the positioning information being based on a combination of RF data and visual data, where the RF data and the visual data are associated with the environment and communicate with the server in accordance with the positioning information that is based on the combination of both the RF data and the visual data.

Another wireless device for wireless communications is described. The wireless device may include means for outputting, to a server, positioning information associated with the wireless device within an environment, the positioning information being based on a combination of RF data and visual data, where the RF data and the visual data are associated with the environment and means for communicating with the server in accordance with the positioning information that is based on the combination of both the RF data and the visual data.

A non-transitory computer-readable medium storing code for wireless communications is described. The code may include instructions executable by one or more processors to output, to a server, positioning information associated with the wireless device within an environment, the positioning information being based on a combination of RF data and visual data, where the RF data and the visual data are associated with the environment and communicate with the server in accordance with the positioning information that is based on the combination of both the RF data and the visual data.

In some examples of the method, wireless devices, and non-transitory computer-readable medium described herein, outputting the positioning information may include operations, features, means, or instructions for outputting, to the server, a request for a positioning estimate of the wireless device, the positioning estimate indicating a location of the wireless device within the environment and outputting, to the server in conjunction with the request for the positioning estimate, a capability message including an indication of one or more sensors associated with the wireless device, information associated with the one or more sensors, or both, where the positioning information includes the request for the positioning estimate and the capability message.

Some examples of the method, wireless devices, and non-transitory computer-readable medium described herein may further include operations, features, means, or instructions for obtaining, from the server, an indication of a configuration for the wireless device to collect and output one or more positioning measurements that include a combination of RF-based positioning measurements and visual-based positioning measurements, the configuration being in accordance with capabilities of the wireless device indicated via the capability message, outputting, to the server, the one or more positioning measurements in accordance with the configuration, and obtaining, from the server, the positioning estimate and a confidence score associated with the positioning estimate, the positioning estimate being based on the one or more positioning measurements.

In some examples of the method, wireless devices, and non-transitory computer-readable medium described herein, communicating with the server in accordance with the positioning information may include operations, features, means, or instructions for obtaining, from the server, an indication to adapt the configuration for the wireless device to collect and output the one or more positioning measurements, an indication to adapt a power-saving mode of the wireless device, an indication to disable visual-based data collection, or any combination thereof based on the positioning estimate, the confidence score of the positioning estimate, or both.

In some examples of the method, wireless devices, and non-transitory computer-readable medium described herein, the one or more positioning measurements may be output in accordance with a periodicity.

Some examples of the method, wireless devices, and non-transitory computer-readable medium described herein may further include operations, features, means, or instructions for outputting, to the server, a request for a first subset of mapping information of a set of mapping information associated with the environment in conjunction with outputting the positioning information, the set of mapping information including information associated with one or more portions of the environment, where the positioning information includes an indication of a position of the wireless device within the environment that may be based on the combination of the RF data and the visual data and obtaining, from the server and in response to the request for the first subset of mapping information, an indication of the first subset of mapping information.

Some examples of the method, wireless devices, and non-transitory computer-readable medium described herein may further include operations, features, means, or instructions for outputting, to the server, one or more positioning information reports that may be based on the combination of the RF data and the visual data, the one or more positioning information reports being associated with the first subset of mapping information based on obtaining the indication of the first subset of mapping information and obtaining, from the server, an indication of a second subset of mapping information based on at least one positioning information report of the one or more positioning information reports of the positioning information.

In some examples of the method, wireless devices, and non-transitory computer-readable medium described herein, the at least one positioning information report indicates that the wireless device may be at a boundary of a respective portion of the environment of the one or more portions of the environment that may be associated with the first subset of mapping information.

In some examples of the method, wireless devices, and non-transitory computer-readable medium described herein, the one or more positioning information reports may be output in accordance with a periodicity.

In some examples of the method, wireless devices, and non-transitory computer-readable medium described herein, communicating with the server in accordance with the positioning information may include operations, features, means, or instructions for obtaining, from the server, an indication to perform RF-based positioning procedures, to perform visual-based positioning procedures, or both to obtain a respective positioning estimate and a respective confidence score associated with the respective positioning estimate.

Some examples of the method, wireless devices, and non-transitory computer-readable medium described herein may further include operations, features, means, or instructions for obtaining the indication may be based on whether the respective confidence score associated with the respective positioning estimate satisfies a confidence threshold, an iteration quantity threshold, or both.

In some examples of the method, wireless devices, and non-transitory computer-readable medium described herein, the positioning information may be output within a positioning protocol procedure and communications with the server may be in accordance with the positioning protocol procedure.

A method for wireless communications by a wireless device is described. The method may include outputting, to a server, a request for a first subset of mapping information of a set of mapping information associated with an environment, the set of mapping information including information associated with one or more portions of the environment, where the request includes an indication of positioning information associated with the wireless device within the environment, obtaining, from the server and in response to the request, an indication of the first subset of mapping information, outputting, to the server, one or more positioning information reports associated with the first subset of mapping information, and obtaining, from the server, an indication of a second subset of mapping information based on at least one positioning information report of the one or more positioning information reports.

A wireless device for wireless communications is described. The wireless device may include one or more memories storing processor executable code, and one or more processors coupled with the one or more memories. The one or more processors may individually or collectively be operable to execute the code to cause the wireless device to output, to a server, a request for a first subset of mapping information of a set of mapping information associated with an environment, the set of mapping information including information associated with one or more portions of the environment, where the request includes an indication of positioning information associated with the wireless device within the environment, obtain, from the server and in response to the request, an indication of the first subset of mapping information, output, to the server, one or more positioning information reports associated with the first subset of mapping information, and obtain, from the server, an indication of a second subset of mapping information based on at least one positioning information report of the one or more positioning information reports.

Another wireless device for wireless communications is described. The wireless device may include means for outputting, to a server, a request for a first subset of mapping information of a set of mapping information associated with an environment, the set of mapping information including information associated with one or more portions of the environment, where the request includes an indication of positioning information associated with the wireless device within the environment, means for obtaining, from the server and in response to the request, an indication of the first subset of mapping information, means for outputting, to the server, one or more positioning information reports associated with the first subset of mapping information, and means for obtaining, from the server, an indication of a second subset of mapping information based on at least one positioning information report of the one or more positioning information reports.

A non-transitory computer-readable medium storing code for wireless communications is described. The code may include instructions executable by one or more processors to output, to a server, a request for a first subset of mapping information of a set of mapping information associated with an environment, the set of mapping information including information associated with one or more portions of the environment, where the request includes an indication of positioning information associated with the wireless device within the environment, obtain, from the server and in response to the request, an indication of the first subset of mapping information, output, to the server, one or more positioning information reports associated with the first subset of mapping information, and obtain, from the server, an indication of a second subset of mapping information based on at least one positioning information report of the one or more positioning information reports.

In some examples of the method, wireless devices, and non-transitory computer-readable medium described herein, the at least one positioning information report indicates that the wireless device may be at a boundary of a respective portion of the environment of the one or more portions of the environment that may be associated with the first subset of mapping information.

In some examples of the method, wireless devices, and non-transitory computer-readable medium described herein, the one or more positioning information reports may be output in accordance with a periodicity.

Some examples of the method, wireless devices, and non-transitory computer-readable medium described herein may further include operations, features, means, or instructions for positioning information associated with the wireless device within the environment and the one or more positioning information reports may be associated with RF data, visual data, or a combination thereof.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports energy efficient positioning procedures in accordance with one or more aspects of the present disclosure.

FIG. 2 shows an example of a wireless network structure that supports energy efficient positioning procedures in accordance with one or more aspects of the present disclosure.

FIG. 3 shows an example of a network architecture that supports energy efficient positioning procedures in accordance with one or more aspects of the present disclosure.

FIG. 4 shows an example of a wireless communications system that supports energy efficient positioning procedures in accordance with one or more aspects of the present disclosure.

FIGS. 5 through 7 and FIGS. 8A and 8B show examples of process flows that support energy efficient positioning procedures in accordance with one or more aspects of the present disclosure.

FIGS. 9 and 10 show block diagrams of devices that support energy efficient positioning procedures in accordance with one or more aspects of the present disclosure.

FIG. 11 shows a block diagram of a communications manager that supports energy efficient positioning procedures in accordance with one or more aspects of the present disclosure.

FIG. 12 shows a diagram of a system including a device that supports energy efficient positioning procedures in accordance with one or more aspects of the present disclosure.

FIGS. 13 and 14 show flowcharts illustrating methods that support energy efficient positioning procedures in accordance with one or more aspects of the present disclosure.

FIG. 15 shows an example of wireless communications systems that support energy efficient positioning procedures in accordance with one or more aspects of the present disclosure.

### DETAILED DESCRIPTION

In some examples, wireless devices such as autonomous wireless devices may utilize visual data to perform mapping and positioning procedures. For example, a wireless device may have one or more sensors such as cameras to map an environment (e.g., an indoor environment, an outdoor environment, a mixed environment, or any combination thereof) for positioning procedures. In some cases, the wireless device may be within an environment that lacks distinct visual features which can result in relatively low positioning accuracy due to the similar looking environment. Further, visual-based positioning procedures and mapping techniques may be relatively computationally expensive and the use of sensors to obtain visual data for performing measurements can consume a relatively large quantity of power at a wireless device. In such cases, some wireless devices may lack the power to handle such vision-based positioning procedures and may be expected to recharge often, which can result in an increase in latency. Additionally, or alternatively, some environments may have privacy restrictions (e.g., hospitals, offices, and the like) and vision-based positioning procedures may introduce one or more privacy concerns.

Some of the techniques of the present disclosure describe increasing the quality of measurements for positioning procedures, the accuracy of positioning procedures, and power savings, and decreasing the latency and privacy concerns associated with visual-based positioning procedures. In some cases, in accordance with the techniques of the present disclosure to improve the quality and accuracy of positioning procedures and measurements, a wireless device may output, to a server, positioning information associated with the wireless device within an environment. In some examples, the positioning information may be based on a combination of radio frequency (RF) data and visual data, where the RF data and the visual data are associated with the environment. In some cases, the wireless device may output an indication of the capabilities of the wireless device in conjunction with the positioning information. In response, the server may configure the wireless device to perform both RF-based and visual-based measurements and report the positioning measurements to the server. The server may then use the positioning measurements to generate a positioning estimate of the wireless device within an environment. In some examples, the server may also generate a confidence score of the positioning estimate. Further, based on the positioning estimate, the confidence score, or both, the wireless device may communicate with the server (e.g., transmit messages to the server or receive messages from the server) in accordance with the positioning information being a combination of both the RF data and the visual data. For example, the server may trigger the wireless device to perform one or more actions based on the positioning estimate, the confidence score, or both, to ensure a relatively high-level of accuracy and privacy.

In another example, the wireless device may calculate the positioning estimate and corresponding confidence score and the wireless device may send positioning reports to the server periodically. In such cases, to reduce the power consumption associated with generating the positioning estimate, the wireless device may request the server for a subset of mapping information to reduce the quantity of data for the positioning estimate. Therefore, in accordance with the techniques of the present disclosure, generation of the positioning estimate may be less complex. Additionally, or alternatively, if the wireless device is beginning to move towards a boundary of the subset of mapping information, the server may transmit additional mapping information. Moreover, in some cases, the wireless device may generate the positioning estimate using RF-based measurements and visual-based measurements independently, in conjunction, or both based on an iterative procedure. Additionally, or alternatively, such signaling of positioning requests, positioning estimates, position reports, and the like may be signaled via a positioning protocol procedure. Therefore, the techniques of the present disclosure may enable a wireless device to enhance positioning procedures when in environments without distinguishing features by performing the positioning procedures at the wireless device on a subset of information, utilizing a combination of RF-based and vision-based measurements. Moreover, the techniques of the present disclosure may ensure an increase in accuracy and reliability of positioning procedures while reducing latency and power consumption.

Aspects of the disclosure are initially described in the context of wireless communications systems. Aspects of the disclosure are also described in the context of a wireless network structure. Aspects of the disclosure are further described in the context of a network architecture. Aspects of the disclosure are additionally described in the context of process flows. Aspects of the disclosure are further illustrated by and described with reference to apparatus diagrams, system diagrams, and flowcharts that relate to energy efficient positioning procedures.

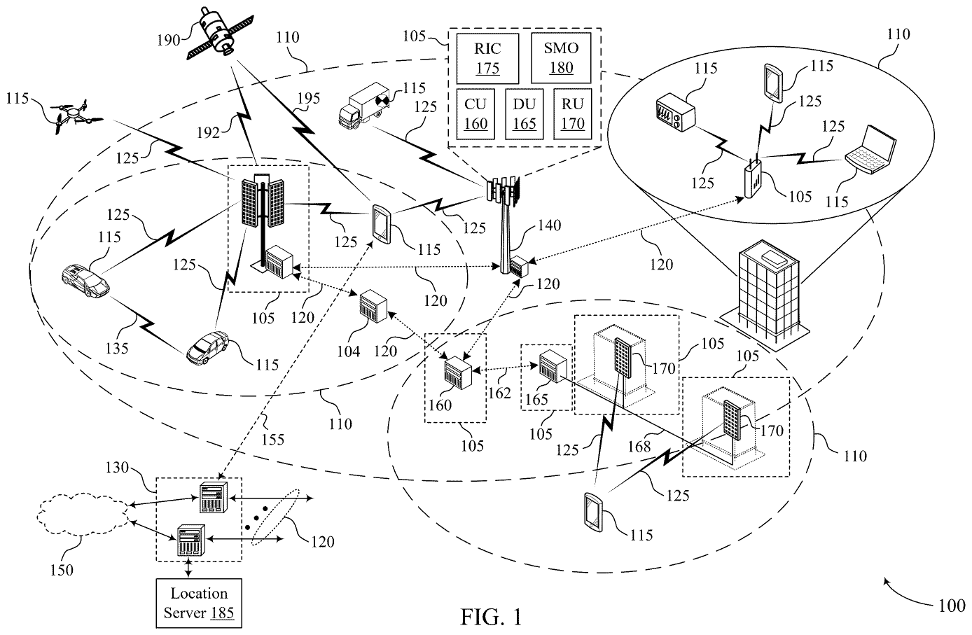

FIG. 1 shows an example of a wireless communications system 100 that supports energy efficient positioning procedures in accordance with one or more aspects of the present disclosure. The wireless communications system 100 may include one or more devices, such as one or more network devices (e.g., network entities or network nodes 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The wireless communications system 100 may include one or more devices, such as one or more network devices (e.g., network nodes 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network nodes 105 may be dispersed throughout a geographic area to form the wireless communications system 100 and may include devices in different forms or having different capabilities. In various examples, a network node 105 may be referred to as a network element, a network entity, a mobility element, a radio access network (RAN) node, or network equipment, among other nomenclature. In some examples, network nodes 105 and UEs 115 may wirelessly communicate via communication link(s) 125 (e.g., a radio frequency (RF) access link). For example, a network node 105 may support a coverage area 110 (e.g., a geographic coverage area) over which the UEs 115 and the network node 105 may establish the communication link(s) 125. The coverage area 110 may be an example of a geographic area over which a network node 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or have different capabilities. Some example UEs 115 are illustrated in FIG. 1. The UEs 115 described herein may be capable of supporting communications with various types of devices in the wireless communications system 100 (e.g., other wireless communication devices, including UEs 115 or network nodes 105), as shown in FIG. 1.

As described herein, a node of the wireless communications system 100, which may be referred to as a network entity or a wireless node, may be a network node 105 (e.g., any network node described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network node 105. As another example, a first node may be configured to communicate with a second node or a third node. In one aspect of this example, the first node may be a UE 115, the second node may be a network node 105, and the third node may be another UE 115. In another aspect of this example, the first node may be a UE 115, the second node may be a network node 105, and the third node may be another network node 105. In yet other aspects of this example, the first, second, and third nodes may be different relative to these examples. Similarly, reference to a UE 115, network node 105, apparatus, device, computing system, or the like may include disclosure of the UE 115, network node 105, apparatus, device, computing system, or the like being a node. For example, disclosure that a UE 115 is configured to receive information from a network node 105 also discloses that a first node is configured to receive information from a second node.

In some examples, network nodes 105 may communicate with a core network 130, or with one another, or both. For example, network nodes 105 may communicate with the core network 130 via wired or wireless backhaul communication link(s) 120 (e.g., in accordance with an S1, N2, N3, or other interface protocol). In some examples, network nodes 105 may communicate with one another via backhaul communication link(s) 120 (e.g., in accordance with an X2, Xn, or other interface protocol) either directly (e.g., directly between network nodes 105) or indirectly (e.g., via the core network 130). In some examples, network nodes 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network nodes 105 or network equipment described herein may include or may be referred to as a base station 140 (e.g., a base transceiver station, a radio base station, an NR base station, an access point (AP), a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network node 105 (e.g., a base station 140) may be implemented in an aggregated (e.g., monolithic, standalone) base station architecture, which may be configured to utilize a protocol stack that is physically or logically integrated within one network node (e.g., a network node 105 or a single RAN node, such as a base station 140).

In some examples, a network node 105 may be implemented in a disaggregated architecture (e.g., a disaggregated base station architecture, a disaggregated RAN architecture), which may be configured to utilize a protocol stack that is physically or logically distributed among multiple network entities (e.g., network nodes 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network node 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a TRP. One or more components of the network nodes 105 in a disaggregated RAN architecture may be co-located, or one or more components of the network nodes 105 may be located in distributed locations (e.g., separate physical locations). In some examples, one or more of the network nodes 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1 interface, F1-c interface, or F1-u, among other examples), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network nodes 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network nodes 105 (e.g., network nodes 105 or IAB node(s) 104) may be partially controlled by each other. The IAB node(s) 104 may be referred to as a donor entity or an IAB donor. A DU 165 or an RU 170 may be partially controlled by a CU 160 associated with a network node 105 or base station 140 (such as a donor network node or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support testing as described herein. For example, some operations described as being performed by a UE 115 or a network node 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network nodes 105 and the network equipment including macro eNBs or gNBs, small cell eNBs or gNBs, or relay base stations, among other examples, as shown in FIG. 1.

The UEs 115 and the network nodes 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network node 105 and other devices may refer to communication between the devices and any portion (e.g., entity, sub-entity) of a network node 105. For example, the terms “transmitting,” “receiving,” or “communicating,” when referring to a network node 105, may refer to any portion of a network node 105 (e.g., a base station 140, a CU 160, a DU 165, a RU 170) of a RAN communicating with another device (e.g., directly or via one or more other network entities, such as one or more of the network nodes 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network node 105 to a UE 115, uplink transmissions (e.g., return link transmissions) from a UE 115 to a network node 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network nodes 105, the UEs 115, or both) may have hardware configurations that support communications using a particular carrier bandwidth or may be configurable to support communications using one of a set of carrier bandwidths. In some examples, the wireless communications system 100 may include network nodes 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network nodes 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network node 105 may provide communication coverage via one or more cells, for example a macro cell, a small cell, a hot spot, or other types of cells, or any combination thereof. The term “cell” may refer to a logical communication entity used for communication with a network node 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network node 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network node 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network node 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network node 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network node (e.g., a network node 105). In some other examples, overlapping coverage areas, such as a coverage area 110, associated with different technologies may be supported by different network entities (e.g., the network nodes 105). The wireless communications system 100 may include, for example, a heterogeneous network in which different types of the network nodes 105 support communications for coverage areas 110 (e.g., different coverage areas) using the same or different RATs.

The wireless communications system 100 may support synchronous or asynchronous operation. For synchronous operation, network nodes 105 (e.g., base stations 140) may have similar frame timings, and transmissions from different network entities (e.g., different ones of the network nodes 105) may be approximately aligned in time. For asynchronous operation, network nodes 105 may have different frame timings, and transmissions from different network entities (e.g., different ones of network nodes 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network node 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network node 105 (e.g., a base station 140, an RU 170), which may support aspects of such D2D communications being configured by (e.g., scheduled by) the network node 105. In some examples, one or more UEs 115 of such a group may be outside the coverage area 110 of a network node 105 or may be otherwise unable to or not configured to receive transmissions from a network node 105. In some examples, groups of the UEs 115 communicating via D2D communications may support a one-to-many (1:M) system in which each UE 115 transmits to one or more of the UEs 115 in the group. In some examples, a network node 105 may facilitate the scheduling of resources for D2D communications. In some other examples, D2D communications may be carried out between the UEs 115 without an involvement of a network node 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network entities (e.g., network nodes 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network nodes 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may include a location server 185 (e.g., LMF). The location server 185 may provide positioning, location, or tracking functions. For instance, the location server 185 may participate in one or more positioning procedures to determine a location of (e.g., coordinates of, relative distance(s) to, or an address of) one or more of the UEs 115. Examples of positioning procedures may include one or more operations of assisted global navigation satellite system (A-GNSS), observed time difference of arrival (OTDOA), enhanced cell identifier (E-CID), sensor-based positioning, wireless local area network (WLAN)-based positioning, Bluetooth-based positioning, terrestrial beacon systems (TBS) positioning, downlink time difference of arrival (DL-TDOA), downlink angle of departure (DL-AOD), multi-round-trip time (Multi-RTT), New Radio enhanced cell identifier (NR E-CID), uplink time difference of arrival (UL-TDOA), and uplink angle of arrival (UL-AOA), among other examples. Some examples of the positioning procedures may be managed by, assisted by, or performed with the location server 185. For instance, measurements associated with reference signaling may be provided to the location server 185, which may estimate a location of a UE 115 based on the measurements. In some aspects, the location server 185 may track or store location information corresponding to one or more UEs 115. Some examples of the positioning procedures may be performed without the location server 185.

The location server 185 may be included in the core network 130 or may be separate from the core network 130. In some examples, a location server 185 may be a standalone device or may be included in (e.g., integrated with) a network node 105, a base station 140, a UE 115, a satellite 190, a server, or another device. For instance, the location server 185 may be (or may be included in) a secure user plane location (SUPL) location platform (SLP) device, a third-party server, or another device. The location server 185 may generally refer to a positioning device, a location device, a computing device, or a server, among other examples.

A UE 115 may communicate with the location server 185 directly or indirectly. For example, a UE 115 may communicate with the location server 185 via a network node 105 that is serving the UE 115 and via the core network 130. Additionally, or alternatively, a UE 115 may communicate with the location server 185 through another path (e.g., via an application server (not shown)) or via another network (e.g., via a WLAN AP), among other examples. Communication between a UE 115 and the location server 185 may be represented via an indirect connection (e.g., through a communication link 125, a network node 105, a communication link 155, a backhaul communication link 120, or the core network 130) or as a direct connection, with one or more intervening nodes (if any) omitted for concision or convenience.

A satellite 190 may be an aerial or space vehicle with signaling capability. In some examples, the wireless communications system 100 may include or communicate with one or more satellites 190. The satellite(s) 190 may be included in one or more satellite positioning systems (e.g., GNSS(s)). A satellite positioning system may include any combination of one or more global or regional navigation satellites associated with one or more satellite positioning systems (e.g., global positioning system (GPS), global navigation satellite system (GLONASS), BeiDou navigation satellite system (BDS), or Galileo, among other examples). A satellite positioning system may include satellites 190 or other transmitters positioned to enable receivers (e.g., UEs 115) to determine a location on or above the Earth based on signals (e.g., the signals 195) received from the satellites 190. For instance, each satellite 190 may transmit a signal 195 marked with a repeating pseudo-random noise (PN) code of a set quantity of chips. In some cases, one or more transmitters located on ground-based control stations, network nodes 105, or UEs 115 may transmit signals for enabling a UE 115 to determine a location.

A UE 115 may include one or more receivers designed to receive the signal(s) 195 from the satellite(s) 190 for determining location information (e.g., a geographic location of the UE 115). For instance, the UE 115 may receive one or more signals 195 from the satellite(s) 190, which may be utilized to determine a location of the UE 115.

In a satellite positioning system, the use of signals 195 may be augmented with one or more satellite-based augmentation systems (SBAS) that may be associated with or enabled for use with one or more global or regional navigation satellite systems. An SBAS may provide integrity information, differential corrections, or other information for use in conjunction with a satellite positioning system. An SBAS may include one or more augmentation systems, such as the Wide Area Augmentation System (WAAS), the European Geostationary Navigation Overlay Service (EGNOS), the Multi-functional Satellite Augmentation System (MSAS), or the GPS Aided Geo Augmented Navigation (GAGAN) system, among other examples.

In some aspects, the satellite(s) 190 may be included in one or more non-terrestrial networks (NTNs). In an NTN, a satellite 190 may communicate with one or more devices (e.g., network entities, ground stations, NTN gateways, or gateways) located on or above the Earth. For example, the satellite 190 may send or receive one or more communications 192 with a network node 105. In some aspects, the communication(s) 192 may include one or more signals relayed to or from a UE 115. Additionally, or alternatively, the satellite 190 may communicate with another terrestrial device that is connected to one or more elements of the wireless communications system 100. For instance, the satellite 190 may communicate with a ground station or NTN gateway, which may provide access to the wireless communications system 100 or one or more other entities (e.g., Internet web servers or one or more other user devices) external to the wireless communications system 100. In some examples, a UE 115 may receive communication signals 195 from the satellite 190 instead of, or in addition to, communication signals from a terrestrial network entity.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network nodes 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize licensed or unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network nodes 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network node 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network node 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network node 105 may be located at diverse geographic locations. A network node 105 may include an antenna array with a set of rows and columns of antenna ports that the network node 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network nodes 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network node 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network node 105 or a UE 115 may use beam sweeping techniques as part of beamforming operations. For example, a network node 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network node 105 multiple times along different directions. For example, the network node 105 may transmit a signal according to different beamforming weight sets associated with different directions of transmission. Transmissions along different beam directions may be used to identify (e.g., by a transmitting device, such as a network node 105, or by a receiving device, such as a UE 115) a beam direction for later transmission or reception by the network node 105.

Some signals, such as data signals associated with a particular receiving device, may be transmitted by a transmitting device (e.g., a network node 105 or a UE 115) along a single beam direction (e.g., a direction associated with the receiving device, such as another network node 105 or UE 115). In some examples, the beam direction associated with transmissions along a single beam direction may be determined based on a signal that was transmitted along one or more beam directions. For example, a UE 115 may receive one or more of the signals transmitted by the network node 105 along different directions and may report to the network node 105 an indication of the signal that the UE 115 received with a highest signal quality or an otherwise acceptable signal quality.

In some examples, transmissions by a device (e.g., by a network node 105 or a UE 115) may be performed using multiple beam directions, and the device may use a combination of digital precoding or beamforming to generate a combined beam for transmission (e.g., from a network node 105 to a UE 115). The UE 115 may report feedback that indicates precoding weights for one or more beam directions, and the feedback may correspond to a configured set of beams across a system bandwidth or one or more sub-bands. The network node 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network node 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network node 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network node 105 or a core network 130 supporting radio bearers for user plane data. A PHY layer may map transport channels to physical channels.

The UEs 115 and the network nodes 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples of the wireless communications system 100, wireless devices (e.g., UEs 115) may utilize a combination of RF-based measurements and vision-based measurements for positioning procedures. Some of the techniques of the present disclosure may describe increasing the quality of measurements for positioning procedures, the accuracy of positioning procedures, and power savings, and decreasing the latency and privacy concerns associated with visual-based positioning procedures. In some cases, in accordance with the techniques of the present disclosure to improve the quality and accuracy of positioning procedures and measurements, a wireless device may utilize a combination of radio frequency (RF)-based and visual-based measurements and transmit the combination of measurements to a server (e.g., the location server 185). The server may then calculate (e.g., generate) a positioning estimate and a corresponding confidence score utilizing the combination of RF-based and visual-based measurements and transmit the positioning estimate and the confidence score to the wireless device.

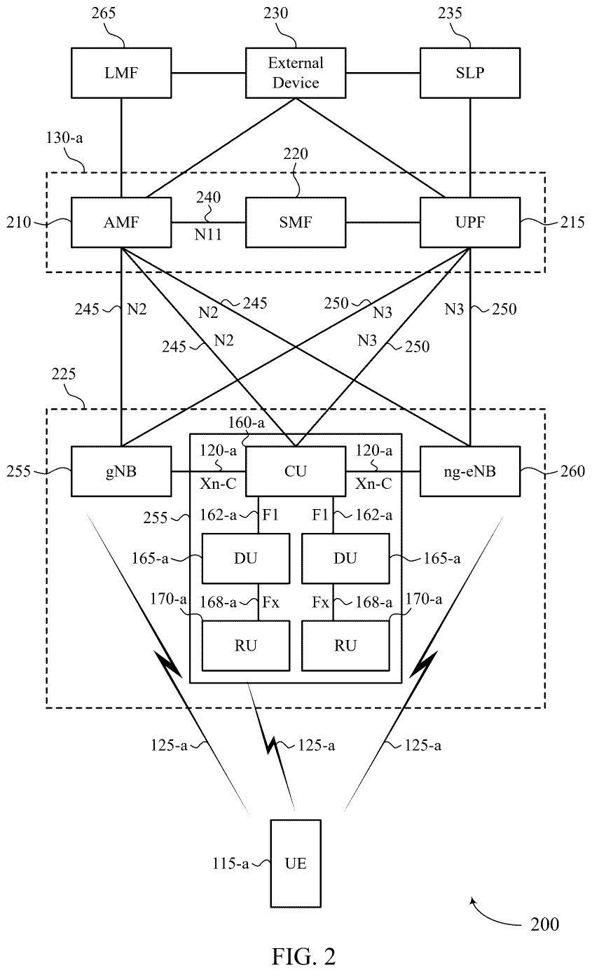

In another example, the wireless device may calculate the positioning estimate and corresponding confidence score based on a subset of mapping information to reduce the power consumption associated with calculating the positioning estimate. Moreover, utilizing the subset of the mapping information may result in a relatively less complex computation procedure at the wireless device to calculate the positioning estimate. Therefore, the techniques of the present disclosure may enable a wireless device to enhance positioning procedures when in environments without distinguishing features by performing the positioning procedures at the wireless device on a subset of information, utilizing a combination of RF-based and vision-based measurements. Moreover, the techniques of the present disclosure may ensure an increase in accuracy and reliability of positioning procedures while reducing latency and power consumption. Further descriptions of the techniques of the present disclosure may be described elsewhere herein, such as with reference to FIGS. 2 through 8

FIG. 2 shows an example of a wireless network structure 200 that supports energy efficient positioning procedures in accordance with one or more aspects of the present disclosure. The wireless network structure 200 may include a core network 130-a, a RAN 225, a UE 115-a, an LMF 265, an external device 230 (e.g., third-party device or server), or an SLP 235. In some examples, the wireless network structure 200 may be included in the wireless communications system 100 described with reference to FIG. 1. The core network 130-a may be an example of the core network 130, the UE 115-a may be an example of the UEs 115, or the LMF 265 may be an example of the location server 185, as described with reference to FIG. 1.

The core network 130-a may provide one or more control plane (C-plane) functions (e.g., UE registration, authentication, network access, or gateway selection, among other examples) or one or more user plane (U-plane) functions (e.g., UE gateway function, data network access, or IP routing, among other examples). One or more of the functions of the core network 130-a may be implemented in one or more devices (e.g., one or more electronic devices, computing devices, servers, among other examples) in hardware (e.g., circuitry) or a combination of hardware and instructions (e.g., a processor with instructions). The core network 130-a may be an EPC, 5GC, or a Next Generation Core (NGC), among other examples.

The core network 130-a may provide an AMF 210, a session management function (SMF) 220, or a user plane function (UPF) 215. The AMF 210 may provide one or more C-plane functions, such as registration management, connection management, reachability management, mobility management, lawful interception, transport for session management (SM) messages between one or more UEs 115-a and the SMF 220, transparent proxy services for routing SM messages, access authentication and access authorization, transport for short message service (SMS) messages between the UE 115-a and the short message service function (SMSF), or security anchor functionality (SEAF), among other examples. In some aspects, the AMF 210 may interact with an authentication server function (AUSF) and the UE 115-a, and may receive an intermediate key established as a result of a UE 115-a authentication process. In a case of authentication based on a universal mobile telecommunications system (UMTS) subscriber identity module (USIM), the AMF 210 may retrieve security information from the AUSF. In some examples, the AMF 210 may provide a security context management (SCM) function. The SCM function may receive a key from the SEAF that may be utilized to derive access-network specific keys. The AMF 210 may provide location services management for regulatory services, transport for location services messages between the UE 115-a and an LMF 265, transport for location services messages between the RAN 225 and the LMF 265, evolved packet system (EPS) bearer identifier allocation for interworking with the EPS, or UE 115-a mobility event notification. In some approaches, the AMF 210 may support one or more functionalities for Third Generation Partnership Project (3GPP) access networks or non-3GPP access networks.

The UPF 215 may provide one or more U-plane functions, such as acting as an anchor point for intra/inter-RAT mobility, acting as an external protocol data unit (PDU) session point of interconnection to a data network, providing packet routing and forwarding, packet inspection, user plane policy rule enforcement (e.g., gating, redirection, or traffic steering), user plane collection (e.g., interception), traffic usage reporting, quality of service (QoS) handling for the U-plane (e.g., uplink or downlink rate enforcement, reflective QoS marking in the downlink), uplink traffic verification (e.g., service data flow (SDF) to QoS flow mapping), transport level packet marking in the uplink or downlink, downlink packet buffering, downlink data notification triggering, or sending or forwarding one or more indications of an end of a transmission (e.g., “end markers”) to a source RAN node, among other examples. In some examples, the UPF 215 may support the transfer of location services messages over a U-plane between the UE 115-a and another device (e.g., the SLP 235 or the external device 230.

The SMF 220 may provide one or more functions, such as session management, UE IP address allocation and management, selection and control of user plane functions, configuration of traffic steering at the UPF 215 to route traffic to a destination, control (e.g., partial control) of policy enforcement or QoS, or downlink data notification. In some aspects, the SMF 220 may communicate with the AMF 210 over an N11 interface 240.

The RAN 225 may include one or more gNBs 255 or one or more ng-eNBs 260. The gNB(s) 255 or the ng-eNB(s) 260 may be examples of the network nodes 105 described with reference to FIG. 1. For instance, a next generation RAN (NG-RAN) may include one or more gNBs 255, or other examples of the RAN 225 may include one or more ng-eNBs 260 or gNBs 255.

The core network 130-a may communicate with the RAN 225 via a C-plane interface 245 (e.g., NG-C or N2 interface) or a U-plane interface 250 (e.g., NG-U or N3 interface). The C-plane interface 245 or the U-plane interface 250 may connect the gNB 255 or the ng-eNB 260 to the core network 130-a (e.g., to one or more control plane functions or one or more user plane functions). For instance, the C-plane interface 245 may connect the AMF 210 to one or more gNBs 255 or ng-eNBs 260 in the RAN 225, or the U-plane interface 250 may connect the UPF 215 to one or more gNBs 255 or ng-eNBs 260 in the RAN 225. The gNB(s) 255 or ng-eNB(s) 260 of the RAN 225 may communicate with each other via one or more backhaul communication links 120-a (e.g., Xn-C interface). The backhaul communication link(s) 120-a may be examples of the backhaul communication links 120 described with reference to FIG. 1. One or more of the gNBs 255 or ng-eNBs 260 may communicate with one or more UEs 115-a over one or more communication links 125-a (e.g., the Uu interface). The communication link(s) 125-a may be examples of the communication links 125 described with reference to FIG. 1.

The LMF 265 may communicate with the core network 130-a to provide location functionality (e.g., to participate in one or more positioning procedures) for the UE(s) 115-a. The LMF 265 may be an example of the location server 185 described with reference to FIG. 1. The LMF 265 may be implemented as one or more devices (e.g., one or more servers, such as physically separate servers, one or more instruction sets on a single server, or instruction sets distributed across multiple physical servers, among other examples). The LMF 265 may support one or more location services for one or more UEs 115-a that may connect to the LMF 265 via the RAN 225, via the core network 130-a, or via another connection (e.g., the Internet). In some examples, the LMF 265 may communicate with a UE 115-a or another device via a C-plane connection (e.g., using one or more interfaces or protocols for signaling control information, or separate from voice or payload data). In some aspects, the LMF 265 may be integrated into a component of the core network 130-a or may be external to the core network 130-a (e.g., on an external device 230, such as an original equipment manufacturer (OEM) server or other server).

In some examples, the SLP 235 may provide location functionality (e.g., may participate in one or more positioning procedures) for the UE(s) 115-a. The SLP 235 may be an example of the location server 185 described with reference to FIG. 1. The SLP 235 may be implemented as one or more devices (e.g., one or more servers, such as physically separate servers, one or more instruction sets on a single server, or instruction sets distributed across multiple physical servers, among other examples). The SLP 235 may support one or more location services for one or more UEs 115-a that may connect to the SLP 235 via the RAN 225, via the core network 130-a, or via another connection (e.g., the Internet). In some examples, the SLP 235 may communicate with a UE 115-a or another device via a U-plane connection (e.g., using one or more interfaces or protocols for signaling voice or payload data, such as a transmission control protocol (TCP) or IP).

In some examples, the external device 230 may communicate with the LMF 265, the SLP 235, the core network 130-a (e.g., via the AMF 210 or the UPF 215), the RAN 225, or the UE 115-a to obtain location information (e.g., a location estimate) for the UE 115-a. The external device 230 may be referred to as a location services (LCS) client or an external client. The external device 230 may be implemented as one or more devices (e.g., one or more servers, such as physically separate servers, one or more instruction sets on a single server, or instruction sets distributed across multiple physical servers, among other examples). The external device 230 may support one or more location services for one or more UEs 115-a that may connect to the external device 230 via the RAN 225, via the core network 130-a, or via another connection (e.g., the Internet).

In some approaches, the functionality of a gNB 255 may be divided between a CU 160-a, one or more DUs 165-a, or one or more RUs 170-a. The CU 160-a may be an example of the CU 160 described with reference to FIG. 1, the one or more DUs 165-a may be examples of the DU 165 described with reference to FIG. 1, or the one or more RUs 170-a may be examples of the RU 170 described with reference to FIG. 1. In some examples, the CU 160-a may provide one or more functions, such as transferring user data, mobility control, radio access network sharing, positioning, session management, or others, except for one or more functions allocated exclusively to the DU(s) 165-a. A DU 165-a may support one or more cells. The DUs 165-a may communicate with the CU 160-a via midhaul communication links 162-a (e.g., via the F1 interface). The midhaul communication links 162-a may be examples of the midhaul communication links 162 described with reference to FIG. 1. The RUs 170-a may perform one or more functions such as power amplification, signal transmission, or signal reception. The RUs 170-a may communicate with the DUs 165-a via fronthaul communication links 168-a (e.g., via the Fx interface). The fronthaul communication links 168-a may be examples of the fronthaul communication links 168 described with reference to FIG. 1. The UE 115-a may communicate with the gNB 255, RU 170-a, or ng-eNB 260 a via communication links 125-a. The communication links 125-a may be examples of the communication links 125 described with reference to FIG. 1. The UE 115-a may communicate with the CU 160-a via the RRC, SDAP, and PDCP layers, with a DU 165-a via the RLC and MAC layers, or with an RU 170-a via the PHY layer.

In some examples of the wireless network structure 200, wireless devices (e.g., the UE 115-a) may utilize a combination of RF-based measurements and vision-based measurements for positioning procedures. Some of the techniques of the present disclosure may describe increasing the quality of measurements for positioning procedures, the accuracy of positioning procedures, and power savings, and decreasing the latency and privacy concerns associated with visual-based positioning procedures. In some cases, in accordance with the techniques of the present disclosure to improve the quality and accuracy of positioning procedures and measurements, a wireless device may utilize a combination of radio frequency (RF)-based and visual-based measurements and transmit the combination of measurements to a server. In some examples, the server may be associated with an LMF 265, a network node 105, or any combination thereof. The server may then calculate (e.g., generate) a positioning estimate and a corresponding confidence score utilizing the combination of RF-based and visual-based measurements and transmit the positioning estimate and the confidence score to the wireless device.

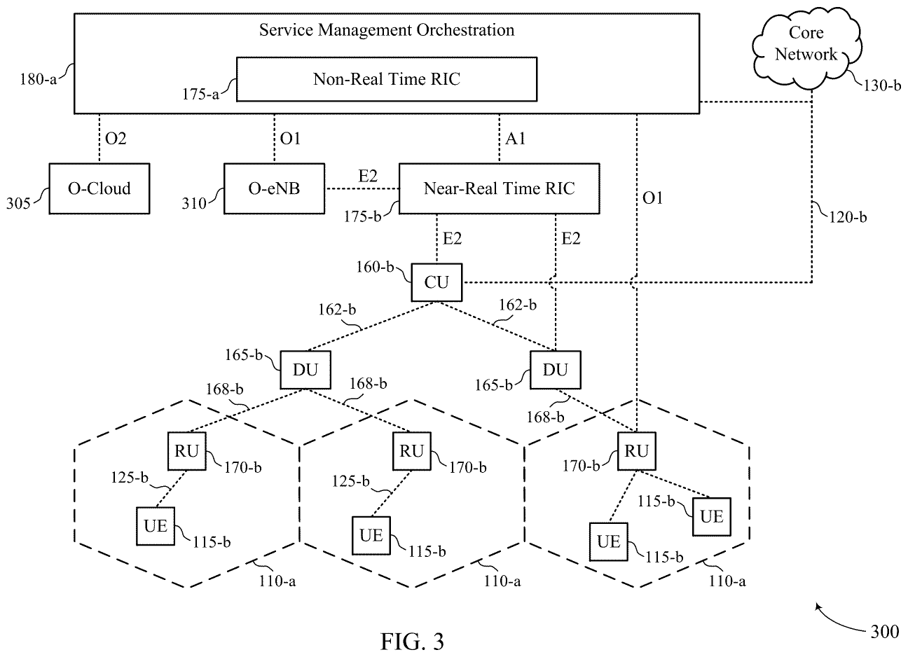

In another example, the wireless device may calculate the positioning estimate and corresponding confidence score based on a subset of mapping information to reduce the power consumption associated with calculating the positioning estimate. Moreover, utilizing the subset of the mapping information may result in a relatively less complex computation procedure at the wireless device to calculate the positioning estimate. Therefore, the techniques of the present disclosure may enable a wireless device to enhance positioning procedures when in environments without distinguishing features by performing the positioning procedures at the wireless device on a subset of information, utilizing a combination of RF-based and vision-based measurements. Moreover, the techniques of the present disclosure may ensure an increase in accuracy and reliability of positioning procedures while reducing latency and power consumption. Further descriptions of the techniques of the present disclosure may be described elsewhere herein, such as with reference to FIGS. 3 through 8

FIG. 3 shows an example of a network architecture 300 (e.g., a disaggregated base station architecture, a disaggregated RAN architecture) that supports energy efficient positioning procedures in accordance with one or more aspects of the present disclosure. The network architecture 300 may illustrate an example for implementing one or more aspects of the wireless communications system 100. The network architecture 300 may include one or more CUs 160-b that may communicate directly with a core network 130-b via a backhaul communication link 120-b, or indirectly with the core network 130-b through one or more disaggregated network nodes 105 (e.g., a Near-RT RIC 175-b via an E2 link, or a Non-RT RIC 175-a associated with an SMO 180-a (e.g., an SMO Framework), or both). A CU 160-b may communicate with one or more DUs 165-b via respective midhaul communication links 162-b (e.g., an F1 interface). The DUs 165-b may communicate with one or more RUs 170-b via respective fronthaul communication links 168-b. The RUs 170-b may be associated with respective coverage areas 110-a and may communicate with UEs 115-b via one or more communication links 125-b. In some implementations, a UE 115-b may be simultaneously served by multiple RUs 170-b.

Each of the network nodes 105 of the network architecture 300 (e.g., CUs 160-b, DUs 165-b, RUs 170-b, Non-RT RICs 175-a, Near-RT RICs 175-b, SMOs 180-a, Open Clouds (O-Clouds) 305, Open eNBs (O-eNBs) 310) may include one or more interfaces or may be coupled with one or more interfaces configured to receive or transmit signals (e.g., data, information) via a wired or wireless transmission medium. Each network node 105, or an associated processor (e.g., controller) providing instructions to an interface of the network node 105, may be configured to communicate with one or more of the other network nodes 105 via the transmission medium. For example, the network nodes 105 may include a wired interface configured to receive or transmit signals over a wired transmission medium to one or more of the other network nodes 105. Additionally, or alternatively, the network nodes 105 may include a wireless interface, which may include a receiver, a transmitter, or transceiver (e.g., an RF transceiver) configured to receive or transmit signals, or both, over a wireless transmission medium to one or more of the other network nodes 105.

In some examples, a CU 160-b may host one or more higher layer control functions. Such control functions may include RRC, PDCP, SDAP, or the like. Each control function may be implemented with an interface configured to communicate signals with other control functions hosted by the CU 160-b. A CU 160-b may be configured to handle user plane functionality (e.g., CU-UP), control plane functionality (e.g., CU-CP), or a combination thereof. In some examples, a CU 160-b may be logically split into one or more CU-UP units and one or more CU-CP units. A CU-UP unit may communicate bidirectionally with the CU-CP unit via an interface, such as an E1 interface when implemented in an O-RAN configuration. A CU 160-b may be implemented to communicate with a DU 165-b, as necessary, for network control and signaling.

A DU 165-b may correspond to a logical unit that includes one or more functions (e.g., base station functions, RAN functions) to control the operation of one or more RUs 170-b. In some examples, a DU 165-b may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-b may further host one or more low PHY layers. Each layer may be implemented with an interface configured to communicate signals with other layers hosted by the DU 165-b, or with control functions hosted by a CU 160-b.

In some examples, lower-layer functionality may be implemented by one or more RUs 170-b. For example, an RU 170-b, controlled by a DU 165-b, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-b may be implemented to handle over the air (OTA) communication with one or more UEs 115-b. In some implementations, real-time and non-real-time aspects of control and user plane communication with the RU(s) 170-b may be controlled by the corresponding DU 165-b. In some examples, such a configuration may enable a DU 165-b and a CU 160-b to be implemented in a cloud-based RAN architecture, such as a vRAN architecture.

The SMO 180-a may be configured to support RAN deployment and provisioning of non-virtualized and virtualized network nodes 105. For non-virtualized network nodes 105, the SMO 180-a may be configured to support the deployment of dedicated physical resources for RAN coverage requirements which may be managed via an operations and maintenance interface (e.g., an O1 interface). For virtualized network nodes 105, the SMO 180-a may be configured to interact with a cloud computing platform (e.g., an O-Cloud 305) to perform network node life cycle management (e.g., to instantiate virtualized network nodes 105) via a cloud computing platform interface (e.g., an O2 interface). Such virtualized network nodes 105 can include, but are not limited to, CUs 160-b, DUs 165-b, RUs 170-b, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-b via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, artificial intelligence (AI) or machine learning (ML) workflows including model training and updates, or policy-based guidance of applications/features in the Near-RT RIC 175-b. The Non-RT RIC 175-a may be coupled with or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-b, one or more DUs 165-b, or both, as well as an O-eNB 310, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

In some examples of the network architecture 300, wireless devices (e.g., the UE 115-a) may utilize a combination of RF-based measurements and vision-based measurements for positioning procedures. Some of the techniques of the present disclosure may describe increasing the quality of measurements for positioning procedures, the accuracy of positioning procedures, and power savings, and decreasing the latency and privacy concerns associated with visual-based positioning procedures. In some cases, in accordance with the techniques of the present disclosure to improve the quality and accuracy of positioning procedures and measurements, a wireless device may utilize a combination of radio frequency (RF)-based and visual-based measurements and transmit the combination of measurements to a server. In some examples, the server may be associated with an LMF, a sensing management function (SnMF), a network node 105, a CU 160b, a DU 165b, an RU 170b, or a combination thereof. The server may then calculate (e.g., generate) a positioning estimate and a corresponding confidence score utilizing the combination of RF-based and visual-based measurements and transmit the positioning estimate and the confidence score to the wireless device.

In another example, the wireless device may calculate the positioning estimate and corresponding confidence score based on a subset of mapping information to reduce the power consumption associated with calculating the positioning estimate. Moreover, utilizing the subset of the mapping information may result in a relatively less complex computation procedure at the wireless device to calculate the positioning estimate. Therefore, the techniques of the present disclosure may enable a wireless device to enhance positioning procedures when in environments without distinguishing features by performing the positioning procedures at the wireless device on a subset of information, utilizing a combination of RF-based and vision-based measurements. Moreover, the techniques of the present disclosure may ensure an increase in accuracy and reliability of positioning procedures while reducing latency and power consumption. Further descriptions of the techniques of the present disclosure may be described elsewhere herein, such as with reference to FIGS. 3 through 8

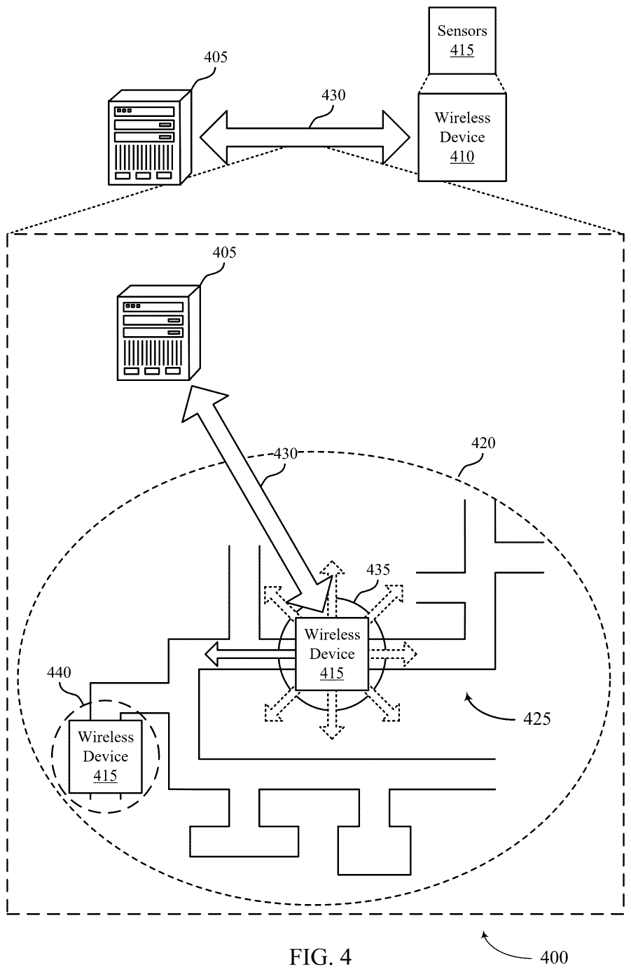

FIG. 4 shows an example of a wireless communications system 400 that supports energy efficient positioning procedures in accordance with one or more aspects of the present disclosure. The wireless communications system 400 may implement aspects of or may be implemented by aspects of the wireless communications system 100. For example, the wireless communications system 400 includes a server 405 and a wireless device 410 that is associated with one or more sensors 415. In some examples, the wireless device 410, or both may be examples of a UE 115, network node 105, RU 170, DU 165, or CU 160 described with reference to FIG. 1, a UE 115-a, gNB 255, RU 170-a, DU 165-a, CU 160-a, or ng-eNB 260 described with reference to FIG. 2, or a UE 115-b, RU 170-b, DU 165-b, or CU 160-b described with reference to FIG. 3. In some other examples, the server 405 may be examples of a network node 105, location server 185, RU 170, DU 165, or CU 160 described with reference to FIG. 1, an LMF 265, external device 230, SLP 235, AMF 210, SMF 220, UPF 215, gNB 255, RU 170-a, DU 165-a, CU 160-a, or ng-eNB 260 described with reference to FIG. 2, an RU 170-b, DU 165-b, or CU 160-b described with reference to FIG. 3, an SnMF, or another device.

In some examples, the wireless device 410 may be utilize the one or more sensors 415 for one or more positioning procedures within an environment 420. In some cases, the environment 420 may be indoors, outdoors, or a mix of both indoors and outdoors (e.g., the environment 420 is a mixed environment) For example, the one or more sensors 415 may include visual-based sensors such as cameras, webcams, and the like. In some cases, to determine positioning estimates, the wireless device 410 may utilize the one or more sensors within visual simultaneous location and mapping (SLAM) procedures. Visual SLAM procedures may include the wireless device 410, the server 405, or both calculating a position and orientation of the wireless device 410 with respect to an environment 420 while simultaneously mapping (e.g., generating a map 425 of the environment 420) the environment 420 based on measurements from the one or more sensors 415 (e.g., cameras) of the wireless device 410.

In some cases, visual SLAM and other positioning procedures that use visual-based data from the one or more sensors 415 of the wireless device may be used for indoor positioning. For example, the wireless device 410 may be utilized as an autonomous robot or device that is configured to deliver items in hospitals, hotels, offices, retail stores, restaurants, and other types of indoor environments. In some other cases, visual SLAM may be used for outdoor or mixed environment positioning. For example, the wireless device 410 may be utilized as an autonomous robot or device for outdoor environments or both indoor and outdoor environments. Although, visual SLAM techniques and procedures may rely on an environment 420 having distinct visual features. Therefore, visual SLAM techniques and procedures may have relatively low position estimation accuracy within an environment 420 that is similar looking and lacks distinct visual features (e.g., hotels, offices, retail stores, and the like where the visual features are relatively similar throughout the environment 420). For example, a viewpoint within a map 425 of an environment 420 of a hotel that faces into a corridor or hallway of the hotel may be relatively similar and resemble other corridors or hallways within the hotel (e.g., within the map 425 of the environment 420).

Further, the wireless device 410 may expect relatively frequent recharging when performing or executing visual SLAM techniques or procedures. For example, visual SLAM may utilize one or more sensors 415 of the wireless device 410 that are different (e.g., cameras and radios) and the wireless device 410 may report the measurements relatively frequently which can result in a relatively high level of power consumption. Moreover, the wireless device 410 may locally run the computations associated with the visual SLAM procedure which may be computationally expensive resulting in an increase in power consumption at the wireless device 410. Additionally, or alternatively, using one or more sensors 415 of the wireless device 410 that are vision-based may result in one or more privacy concerns. For example, in an environment 420 such as a hospital or an office that may include sensitive information, using one or more sensors 415 that are vision-based can result in one or more security risks due to sensitive information being exposed by the one or more sensors 415 of the wireless device 410 that are vision-based.

In accordance with the techniques of the present disclosure, the server 405 and the wireless device 410 may interact and communicate based on the characteristics of the wireless device 410 to adapt a positioning procedure accordingly. For example, the techniques of the present disclosure may describe collecting a relatively higher quality of data for improved positioning based on utilizing a combination of RF-based and vision-based measurements. In another example, the techniques of the present disclosure may describe enhanced power savings based on switching between using RF-based and vision-based measurements. Thus, the techniques of the present disclosure may result in the wireless device 410 conserving power while improving positioning accuracy (e.g., by providing indications for acquiring relatively high-quality measurements) for the wireless device 410 (e.g., autonomous devices). Further, the wireless device 410 may utilize RF-based measurements to down-select regions of a map 425 before implementing vision-based procedures. Thus, the wireless device 410 may improve positioning procedures in an environment 420 that is relatively similar looking.

In some examples, in accordance with the techniques of the present disclosure, the wireless device 410 and the server 405 may interact via a communication link 430. For example, the wireless device 410 may output (e.g., transmit), to the server 405 via the communication link 430, positioning information associated with the wireless device 410 within the environment 420. In some cases, the positioning information may be based on a combination of RF data and visual data. Moreover, the RF and visual data may be associated with the environment 420. For example, the RF data and visual data may include RF-based measurements and vision-based measurements obtained via the one or more sensors 415 of the wireless device 410 within the environment 420.

In some implementations, a localization or positioning procedure to determine a position 435 of the wireless device 410 may be performed at the server 405. For example, the server 405 may utilize the RF-based and vision-based measurements from the wireless device 410 and generate a positioning estimate and a corresponding confidence score. In some cases, the positioning estimate may be an estimate obtained (e.g., calculated or generated) by the server 405 of the position 435 of the wireless device 410 and the positioning estimate may be associated with a confidence score that indicates a level of confidence in the estimate. In some examples, a relatively high confidence score may indicate that the server 405 is relatively confident of the position 435 of the wireless device 410 and a relatively low confidence score may indicate that the server 405 is unsure of the position 435 of the wireless device 410. Based on the localization confidence or accuracy (e.g., the value of the confidence score) and information associated with the wireless device 410 within the map 425 of the environment 420 (e.g., geofencing information), the server 405 may provide indications (e.g., messages) to the wireless device 410 accordingly. For example, the server 405 may indicate for the wireless device 410 to tune a power mode, a measurement frequency, a level of data quality, to switch off one or more sensors 415 (e.g., a camera), or any combination thereof.

In some other implementations, the localization (e.g., the predicting of the position 435 of the wireless device 410) may be performed by the wireless device 410. For example, in accordance with the techniques of the present disclosure, the wireless device 410 may request the wireless device 410 for a submap of the map 425 based on the position 435 of the wireless device 410 (e.g., a current position) to relatively more precisely localize the wireless device 410 within the map 425. In some cases, a submap of the map 425 may be an example of a respective floor of a multi-floor building. For example, the map 425 may be a two-dimensional (2D) or three-dimensional (3D) map of a multi-floor building that includes two or more floors and the map 425 may include a submap for each floor of the two or more floors of the multi-floor building. In another example, the map 425 may represent a single floor of a building and each submap may represent respective rooms, hallways, wings, corridors, or any combination thereof of a respective floor. Such procedure of using a submap of the map 425 for positioning procedures may improve the accuracy of the positioning procedure and reduce the power consumption at the wireless device 410. For example, rather than attempting to estimate the position 435 of the wireless device 410 within the map 425, the wireless device 410 may use a subset of the map 425, thus reducing the quantity of data associated with the positioning procedure which in turn reduces the quantity of computations for the positioning procedure which can result in a reduction in power consumption at the wireless device 410.

Once estimated, the wireless device 410 may then output (e.g., transmit) a report to the server 405 indicating the position 435 of the wireless device 410. Additionally, or alternatively, as the wireless device 410 may move within the map 425 of the environment 420 (e.g., as illustrated via the arrows surrounding the wireless device 410), the server 405 may output an updated submap as the wireless device 410 reaches close to a boundary of the submap. For example, the map 425 illustrated herein may represent a submap of a map that covers the environment 420 and the wireless device 410 may move to a position 440 within the map 425 that is at a map 425 boundary. In some examples, as the wireless device 410 may report the location (e.g., positioning estimate) of the wireless device 410 to the server 405 relatively frequently (e.g., periodically, semi-periodically, aperiodically), the server 405 may detect when that the position 440 may be at a boundary of the map 425. In response, the server 405 may output a second submap of the environment 420 to the wireless device 410 such that as the wireless device 410 leaves the boundary of the map 425 the wireless device 410 may be capable of accurately and efficiently predicting the location of the wireless device 410 without utilizing data associated with the entire environment 420.

In some cases, in accordance with the techniques of the present disclosure, the server 405, the wireless device 410, or both, may determine that vision-based positioning procedures alone may be inefficient or ineffective in an environment 420 that looks relatively similar. Thus, the server 405, the wireless device 410, or both may utilize a positioning procedure that iteratively combines both RF-based and vision-based positioning to improve the accuracy of a positioning procedure. Additionally, or alternatively, the techniques of the present disclosure may also be implemented into one or more positioning procedure protocols between a wireless device 410 and an LMF entity. For example, signaling associated with the techniques of the present disclosure may be included within LTE positioning protocol (LPP) procedures.

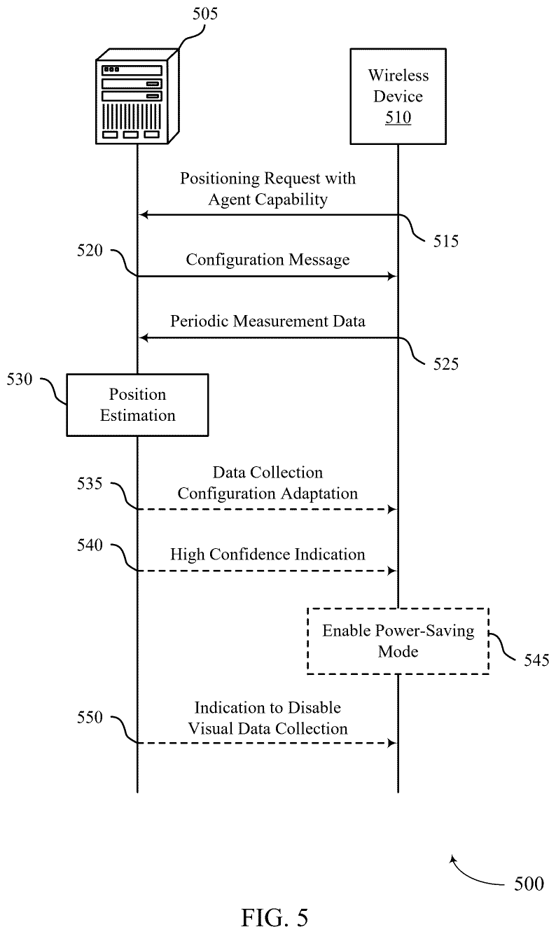

Thus, in accordance with the techniques of the present disclosure, wireless devices 410 and servers 405 may interact to improve the efficiency, accuracy, reliability, and power consumption levels of positioning procedures. For example, utilizing the techniques of the present disclosure, wireless devices 410 (such as autonomous robots) may be capable of efficiently, accurately, and reliably delivering packages within relatively complex indoor environments (e.g., the environment 420) while also addressing privacy concerns (e.g., turning off one or more sensors 415 of the wireless device 410 that are vision-based in sensitive locations). In another example, relatively more accurate positioning estimates obtained in accordance with the techniques of the present disclosure may assist wireless devices 410 (e.g., autonomous robots among other autonomous devices such as autonomous vehicles) in navigating industrial warehouses that lack distinct visual features. Further descriptions of the techniques of the present disclosure may be described elsewhere herein, such as with reference to FIGS. 5 through 7 and 8A-8B.

FIG. 5 shows an example of a process flow 500 that supports energy efficient positioning procedures in accordance with one or more aspects of the present disclosure. In some examples, the process flow 500 may implement or be implemented by the wireless communications system 100, wireless communications system 400, or both. For example, the process flow 500 may include a server 505 and a wireless device 510, which may be examples of devices described herein with reference to FIGS. 1 and 4.

In the following description of the process flow 500, the operations between the server 505 and the wireless device 510 may be performed in different orders or at different times. Some operations may also be left out of the process flow 500, or other operations may be added. Although the server 505 and the wireless device 510 are shown performing the operations of the process flow 500, some aspects of some operations may also be performed by one or more other wireless devices.

At 515, the wireless device 510 may output (e.g., transmit), to the server 505, positioning information associated with the wireless device 510 within an environment. The positioning information may be based on a combination of RF data and visual data. Moreover, the RF data and visual data may be associated with the environment. In some cases, outputting the positioning information may include the wireless device 510 outputting, to the server 505, a request for a positioning estimate of the wireless device 510 where the positioning estimate indicates a location of the wireless device 510 within the environment. Further, the wireless device 510 may also output, to the server 505 in conjunction with the request for the positioning estimate, a capability message that includes an indication of one or more sensors associated with the wireless device 510, information associated with the one or more sensors, or both. In some cases, the wireless device 510 may output, via the capability message, an indication of available sensors at the wireless device 510 and resolutions, bitrates, and other configurations of the available sensors. For example, for a vision-based sensor (e.g., a camera), the wireless device 510 may indicate to the server 505, via the capability message, that the wireless device 510 has the vision-based sensor, whether the vision-based sensor is available to be used for positioning, a resolution of the vision-based sensor, and other information associated with the vision-based sensor. Moreover, the positioning information output at 515 may include both the request for the positioning estimate and the capability message.

At 520, the wireless device 510 may obtain (e.g., receive), from the server 505, an indication of a configuration for the wireless device 510 to collect and output one or more positioning measurements that include a combination of RF-based positioning measurements and visual-based positioning measurements. The configuration may also be in accordance with capabilities of the wireless device indicated via the capability message. In some examples, the server 505 may output (e.g., transmit) the indication of the configuration via a configuration message. In some cases, the configuration message may include an indication of a type of data for the wireless device 510 to output to the server 505. For example, the server 505 may indicate for the wireless device 510 to output vision-based data (e.g., measurements), RF-based data, inertial measurement unit (IMU) data, or any combination thereof. The configuration message may also indicate a rate at which the wireless device 510 should transmit data for each data type (e.g., each measurement data type).

At 525, the wireless device 510 may output (e.g., transmit), to the server 505, the one or more positioning measurements in accordance with the configuration. In some examples, the one or more positioning measurements may be output in accordance with a periodicity. For example, the wireless device 510 may output one or more positioning measurement reports periodically to the server 505. In some cases, the periodicity may be negotiated between the server 505 and the wireless device 510 when establishing a connection, indicated via the configuration, or both. In some examples, the wireless device 510 may transmit the one or more positioning measurements via messages that include metadata and a payload. The metadata of the one or more positioning measurement messages may include an indication of a battery level of the wireless device 510, an indication of a privacy level, a timestamp of the message transmission, an identifier of the wireless device 510, or any combination thereof. The payload of the one or more positioning measurement messages may include the vision-based data, the RF-based data, the IMU data, or any combination thereof.

At 530, the server 505 may generate and output, to the wireless device 510, a positioning estimate and a confidence score associated with the positioning estimate. The positioning estimate may be based on the one or more positioning measurements from the wireless device 510. In some cases, the server 505 may compute (e.g., generate, calculate, obtain) the positioning estimate by using both the RF measurements and the vision measurements. Further, the server 505 may compute the confidence score (e.g., an uncertainty metric) for the positioning estimate to indicate a level of confidence in the position of the wireless device 510 indicated via the positioning estimate.

At 535, the wireless device 510 may obtain, from the server 505, an indication to adapt the configuration for the server 505 to collect and output the one or more positioning measurements based on the positioning estimate and confidence score (e.g., uncertainty metric) calculated at the server 505. For example, if the confidence score associated with the positioning estimate is relatively low (e.g., the server 505 is relatively uncertain of the position of the wireless device 510), the server 505 may indicate an adaptation of the configuration at the wireless device 510 used to collect data. In some cases, the server 505 may determine that the visual-based data is relatively unreliable for generating the positioning estimate, the server 505 may indicate for the wireless device 510 to change viewpoints. For example, the server 505 may indicate for the wireless device 510 to change where a visual-based sensor (e.g., a camera) is pointed. In some examples, such indication may be via textual information such as an indication to “look left” or an indication of an angle for the wireless device 510 to move a sensor (e.g., “move camera 50 degrees east/right”).

In some other cases, the server 505 may determine that the RF-based data is resulting in the positioning estimate to have a relatively low confidence score, thus the server 505 may adapt the configuration used by the wireless device 510 to collect and output the RF-based data. Additionally, or alternatively, a measurement sampling rate at the wireless device 510 may be inversely proportional to the confidence score (e.g., uncertainty metric) associated with the positioning estimate that is based on RF-based positioning measurements, visual-based measurements, or any combination thereof. Thus, if the server 505 calculates a positioning estimate with a relatively low confidence score, the server 505 may indicate for the wireless device 510 to adjust the sampling rate of obtaining (e.g., collecting) and outputting (e.g., reporting) the RF-based positioning measurements, visual-based measurements, or any combination thereof.

At 540, the server 505 may output, to the wireless device 510, an indication of the positioning estimate of the wireless device 510 and that the positioning estimate is associated with a relatively high confidence score. In some examples, in response to the positioning estimate being associated with a relatively high confidence score, the server 505 may indicate for the wireless device 510 to adjust a sampling rate to collect and output positioning measurements in accordance with a relatively longer periodicity (e.g., relatively less frequent). In response to such indication from the server 505, the wireless device 510 may scan for beacons relatively less frequently when the RF-based measurements are relatively reliable. In some other examples, to conserve power at the wireless device 510, the server 505 may indicate for the wireless device 510 to refrain from providing vision information (e.g., visual data from visual-based positioning measurements) for a period of time. In some cases, the server 505 may transmit (e.g., output) such indication via a message for the wireless device 510 to adapt or enable a power-saving mode. Thus, at 545, the wireless device 510 may adapt a power-saving mode of the wireless device 510. For example, the server 505 may output, to the wireless device 510, a message (e.g., a control message) to enable a power-saving mode at the wireless device 510 that is associated with limiting use of one or more sensors (e.g., visual sensors) due a power consumption level associated with the one or more sensors. In some cases, such message may be triggered based on a positioning estimate have a relatively high quality level and being associated with a relatively high confidence score or indication. Subsequently, the wireless device 510 may use RF-based measurements and IMU measurements for tracking a trajectory or movement of the wireless device 510. Further, if the wireless device 510 transmits (e.g., outputs) a positioning estimate that is associated with a confidence score (e.g., a level of uncertainty) that satisfies a threshold, the server 505 or the wireless device 510 may request that visual-based positioning measurement collection be resumed at the wireless device 510.

At 550, the wireless device 510 may obtain (e.g., receive), from the server 505, an indication to disable visual-based data collection based on the positioning estimate of the wireless device 510, the confidence score of the positioning estimate, or both. For example, for privacy reasons, the server 505 may indicate for the wireless device 510 to switch off visual-based sensors (e.g., cameras) based on geofencing. In some examples, geofencing may be a virtual perimeter or boundary that triggers notifications or actions when the wireless device 510 enters, exits, or moves within a geographical area. In some cases, the geographical area may be defined by positioning information such as GPS coordinates or RF information. For example, an area of a building that is associated with sensitive information (e.g., a lobby of a hotel) may be geofenced such that when the server 505 generates a positioning estimate that indicates that the wireless device 510 is within the geofenced area the server 505 may indicate for the wireless device 510 to disable the collection of visual data.

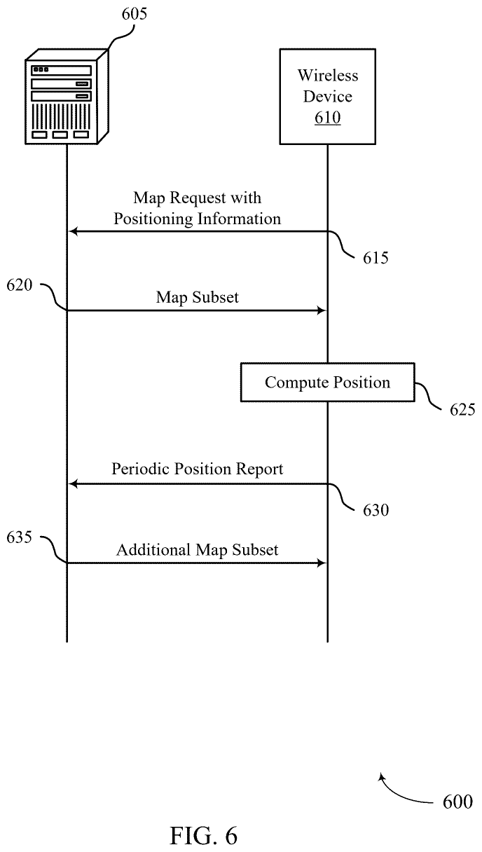

In other examples, the server 505 may utilize an indication of a battery level of the wireless device 510 indicated with the measurement data to determine one or more actions. For example, if the battery level of the wireless device 510 is relatively low, the server 505 may indicate for the wireless device 510 to disable the collection of visual data and to turn off visual-based sensors (e.g., cameras) to decrease the power consumption of the wireless device 510. Additionally, or alternatively, once the wireless device 510 indicates that the battery level of the wireless device 510 is above a threshold level (e.g., the wireless device 510 has charged up to a threshold level) or once the server 505 determines (e.g., via a positioning estimate) that the wireless device 510 is outside a geofenced area, the server 505 may indicate for the wireless device 510 to turn back on or to reenable the collection of visual-based data via visual sensors (e.g., cameras). Moreover, in accordance with the techniques of the present disclosure, the server 505 may output such indications of actions to the wireless device 510 periodically, on-demand, or both to improve the level of power consumption at the wireless device 510, improve the accuracy of positioning procedures, reduce privacy concerns, or any combination thereof. Further descriptions of the techniques of the present disclosure may be described elsewhere herein, such as with reference to FIGS. 6 through 15

FIG. 6 shows an example of a process flow 600 that supports energy efficient positioning procedures in accordance with one or more aspects of the present disclosure. In some examples, the process flow 600 may implement or be implemented by the wireless communications system 100, wireless communications system 400, or both. For example, the process flow 600 may include a server 605 and a wireless device 610, which may be examples of devices described herein with reference to FIGS. 1 and 4.

In the following description of the process flow 600, the operations between the server 605 and the wireless device 610 may be performed in different orders or at different times. Some operations may also be left out of the process flow 600, or other operations may be added. Although the server 605 and the wireless device 610 are shown performing the operations of the process flow 600, some aspects of some operations may also be performed by one or more other wireless devices.

At 615, the wireless device 610 may output (e.g., transmit), to the server 605, a request for a first subset of mapping information of a set of mapping information associated with an environment. The set of mapping information may include information associated with one or more portions of the environment. Moreover, the request may include an indication of positioning information associated with the wireless device 610 within the environment. For example, to enable the wireless device 610 to determine a relatively accurate position of the wireless device 610 within an environment, the wireless device 610 send (e.g., output or transmit) a request for mapping information along with a coarse position of the wireless device 610. In some cases, the coarse position of the wireless device 610 may be obtained via a global positioning system (GPS) signal that indicates a location of the wireless device 610 within an environment. The GPS signal may be obtained by the wireless device 610 or transmitted to the wireless device 610 from another device (e.g., the server 605). In some other cases, the coarse position of the wireless device 610 may be obtained from the server 605 as described in FIG. 5. For example, the wireless device 610 may send the positioning estimate that was determined by the server 605 as the coarse position indication of the wireless device 610 when requesting mapping information from the server 605. In such case, the indication of the position of the wireless device 610 within the environment may be based on a combination of RF data and visual data.

At 620, the wireless device 610 may obtain (e.g., receive), from the server 605 and in response to the request, an indication of the first subset of mapping information. For example, the server 605 may interpret the coarse position of the wireless device 610 and search for a corresponding map in a database at the server 605. Thus, the server 605 may search for and return a map to the wireless device 610 that is a subset of a map of an entire environment which can result in a reduced payload overhead. For example, having the server 605 output (e.g., transmit) the map of the entire environment may result in a relatively high payload overhead and signaling overhead compared to outputting a subset of the entire map. In some examples, the first subset of mapping information may include a map of the portion of the environment that the wireless device 610 is within, as determined by the indication of the position (e.g., the coarse position) of the wireless device 610 indicated via the request for the first subset of mapping information.

At 625, the wireless device 610 may execute a positioning procedure (e.g., a positioning algorithm) using the first subset of mapping information to obtain a relatively more accurate positioning estimate of the wireless device 610 within the environment. In some examples, since the wireless device 610 may move within the environment, the wireless device 610 may use the first subset of mapping information to calculate one or more positioning estimates relatively fast based on utilizing information associated with a relatively small environment. Therefore, utilizing the subset of mapping information may also result in improved accuracy for positioning procedures which can lead to a reduction in false positives that can cause problems in map-based localization procedures.

At 630, the wireless device 610 may output (e.g., transmit), to the wireless device 610, one or more positioning information reports associated with the first subset of mapping information. In some examples, the one or more positioning information reports may be associated with RF data, visual data, or a combination of thereof. For example, the wireless device 610 may output, to the server 605, one or more positioning information reports that are based on a combination of the RF data and the visual data. Moreover, the one or more positioning information reports may be associated with the first subset of mapping information based on obtaining the indication of the first subset of mapping information from the server 605. Additionally, or alternatively, the wireless device 610 may output the one or more positioning information reports in accordance with a periodicity. That is, the wireless device 610 may periodically report the measured or estimated position of the wireless device 610 to the server 605. In some examples, the periodic positioning measurements may aid the server 605 in keeping track of the position of the wireless device 610 within the map subset indicated via the first subset of mapping information.

At 635, the wireless device 610 may obtain (e.g., receive), from the server 605, an indication of a second subset of mapping information based on at least one positioning information report of the one or more positioning information reports. For example, the at least one positioning information report may indicate that the wireless device 610 is at a boundary of a respective portion of the environment of one or more portions of the environment that are associated with the first subset of mapping information. Thus, the server 605 may send (e.g., output or transmit) an updated map of the environment (e.g., a different map subset) when a positioning measurement of the wireless device 610 in a positioning information report indicates that the wireless device 610 is near the boundary of the provided map subset associated with the first subset of mapping information.

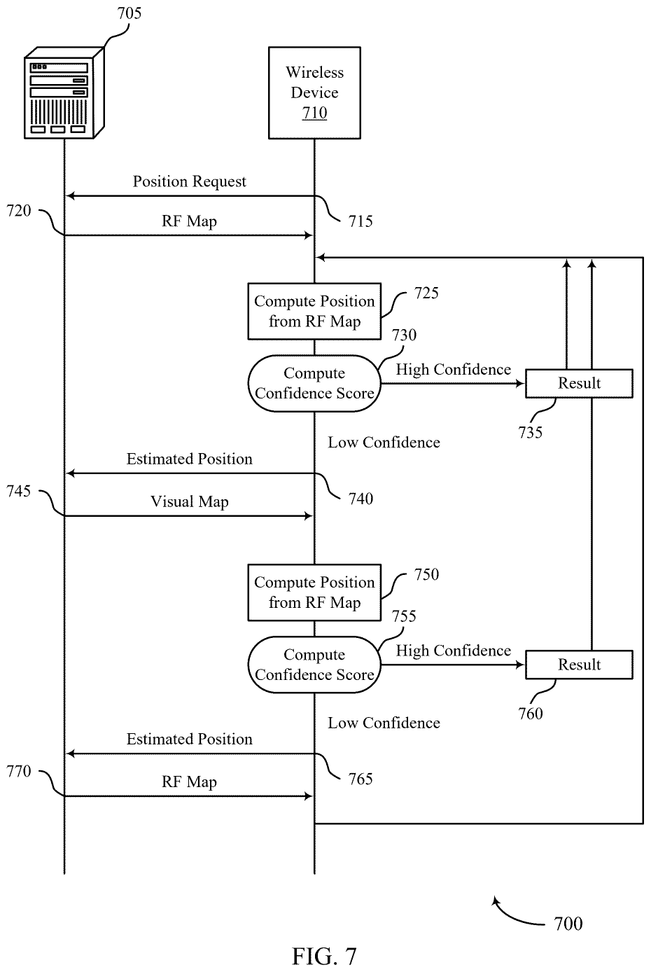

In some cases, the second subset of mapping information may overlap with the first subset of mapping information. For example, at least a portion of the second subset of mapping information may be included within the first subset of mapping information such that the wireless device 610 can switch to utilizing the second subset of mapping information without any discontinuity. In some other cases, the second subset of mapping information may be different from the first subset of mapping information and once the wireless device 610 exits the map subset associated with the first subset mapping information, the wireless device 610 may switch to utilizing the second subset of mapping information for positioning procedures. Additionally, or alternatively, the wireless device 610 may obtain (e.g., receive), from the server 605, an indication to adapt the configuration for the wireless device 610 to collect and output one or more positioning measurements, an indication to adapt a power-saving mode of the wireless device 610, an indication to disable visual-based data collection, or any combination thereof based on a positioning indication or estimate within a respective positioning information report, the confidence score of a positioning indication or estimate, or both. Moreover, in accordance with the techniques of the present disclosure, the server 605 may output such mapping information updates, indications of actions to the wireless device 610, or both periodically, on-demand, or both to improve the level of power consumption at the wireless device 610, improve the accuracy of positioning procedures, reduce privacy concerns, or any combination thereof. Further descriptions of the techniques of the present disclosure may be described elsewhere herein, such as with reference to FIGS. 7 through 15

FIG. 7 shows an example of a process flow 700 that supports energy efficient positioning procedures in accordance with one or more aspects of the present disclosure. In some examples, the process flow 700 may implement or be implemented by the wireless communications system 100, wireless communications system 400, or both. For example, the process flow 700 may include a server 705 and a wireless device 710, which may be examples of devices described herein with reference to FIGS. 1 and 4.

In the following description of the process flow 700, the operations between the server 705 and the wireless device 710 may be performed in different orders or at different times. Some operations may also be left out of the process flow 700, or other operations may be added. Although the server 705 and the wireless device 710 are shown performing the operations of the process flow 700, some aspects of some operations may also be performed by one or more other wireless devices.

At 715, the wireless device 710 may output (e.g., transmit), to the server 705, positioning information associated with the wireless device 710 within an environment. The positioning information may be based on a combination of RF data and visual data and the RF data, and the visual data may be associated with the environment.

At 720, the wireless device 710 may obtain, from the server 705, an indication to perform RF-based positioning procedures to obtain a respective positioning estimate and a respective confidence score associated with the respective positioning estimate. In some cases, the indication to perform the RF-based positioning procedures may also include an indication of an RF-based map of an environment. For example, RF data may be a preferred modality by the wireless device 710 due to relatively less storage and reduced computational complexity compared to visual data. In such examples, at 725, the wireless device 710 may utilize a RF-based positioning procedure to estimate a coarse position of the wireless device 710 within a map that is divided into one or more submaps (e.g., as described with reference to FIG. 6). Further, at 730, the wireless device 710 may generate a confidence score of the positioning estimate obtained and generated utilizing the RF-based positioning procedure. At 735, if the confidence score is relatively high (e.g., the confidence score satisfies a confidence threshold), the result may be finalized and the wireless device 710 may determine such positioning estimate as the position of the wireless device 710. Otherwise, a set of the top-k submaps or submaps with positioning estimates that have confidence scores that satisfy a threshold (e.g., are above a threshold) may be further refined.

At 740, the wireless device 710 may report the positioning estimates of the submaps and the corresponding confidence scores to the wireless device 710. In response, at 745, the wireless device 710 may obtain (e.g., receive), from the server 705, an indication to perform visual-based positioning procedures to obtain a respective positioning estimate of the wireless device 710 and a respective confidence score associated with the respective positioning estimate. For example, the wireless device 710 may obtain one or more visual maps for the locations associated with the positioning estimates reported at 740.

At 750, the wireless device 710 may apply vision-based positioning on the subset of maps and the wireless device 710 may estimate the position of the wireless device 710 within the environment utilizing one or more visual localization algorithms. Further, at 755, the wireless device 710 may obtain (e.g., generate, compute, or calculate) a confidence score associated with a respective positioning estimate that is based on the visual-based positioning procedures. At 760, if the confidence score is relatively high (e.g., the confidence score satisfies a confidence threshold), the result may be finalized and the wireless device 710 may determine such positioning estimate as the position of the wireless device 710. Otherwise, at 765, if the confidence score is relatively low (e.g., the confidence score is unable to satisfy the confidence threshold), the wireless device 710 may output the positioning estimate to the server 705. Further, at 770, the wireless device 710 may obtain another RF-based map for the subset of maps or for the environment. For example, if the confidence is below the confidence threshold, the top-k submaps may be iteratively refined thus reducing the computational load by focusing on the relevant submaps.

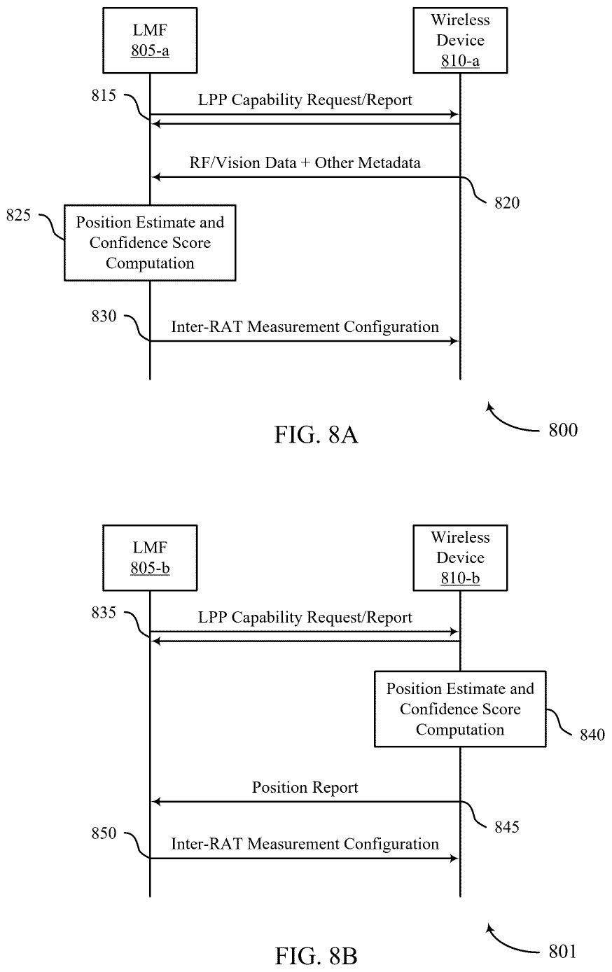

In some cases, the wireless device 710 may be unable to generate a confidence score that satisfies a confidence threshold for both the RF-based positioning procedures and visual-based positioning procedures separately. In such cases, the wireless device 710 may obtain (e.g., receive), from the server 705, an indication to perform both RF-based positioning procedures and visual-based positioning procedures to obtain a respective positioning estimate and a respective confidence score associated with the respective positioning estimate. Additionally, or alternatively, obtaining the indication may be based on whether the respective confidence score associated with the respective positioning estimate satisfies a confidence threshold, an iteration quantity threshold, or both. For example, the procedure outlined by the process flow 700 may be repeated until a position estimate with a confidence score that satisfies a confidence threshold is obtained (e.g., a position with a relatively high confidence is calculated) or until a quantity of iterations of the process flow 700 satisfies an iteration quantity threshold (e.g., a maximum quantity of iterations is reached). Moreover, the iterative procedure of the process flow 700 may be relatively useful for dynamic environments where the mapping information changes or when the mapping information for an environment is relatively outdated. Further, the iterative procedure of the process flow 700 may also be useful for environments have similar looking layouts, when data from RF-based sensors, visual-based sensors, or both are incomplete or unreliable, when RF-based and visual-based maps are provided by different vendors, or any combination thereof. Therefore, the server 705 and the wireless device 710 may utilize the iterative procedure of the process flow 700 to determine a relatively more accurate positioning estimate of the wireless device 710 by determining confidence levels of RF-based positioning procedure estimates, visual-based positioning procedure estimates, or estimates generated using a combination of RF-based positioning procedures and visual-based positioning procedures. Such iterative procedure may thus result in relatively more accurate and reliable positioning estimates which can decrease the latency of communications and improve the efficiency of communications within a wireless communications system. Further descriptions of the techniques of the present disclosure may be described elsewhere herein, such as with reference to FIGS. 8A and 8B and FIGS. 9 through 15

FIG. 8A shows an example of a process flow 800 that supports energy efficient positioning procedures in accordance with one or more aspects of the present disclosure. In some examples, the process flow 800 may implement or be implemented by the wireless communications system 100, wireless communications system 400, or both. For example, the process flow 800 may include an LMF 805-a and a wireless device 810-a, which may be examples of devices described herein with reference to FIGS. 1 and 4.

In the following description of the process flow 800, the operations between the LMF 805-a and the wireless device 810-a may be performed in different orders or at different times. Some operations may also be left out of the process flow 800, or other operations may be added. Although the LMF 805-a and the wireless device 810-a are shown performing the operations of the process flow 800, some aspects of some operations may also be performed by one or more other wireless devices.

At 815, the wireless device 810-a may output (e.g., transmit), to the LMF 805-a, a LPP capability report. In some examples, the wireless device 810-a may output the LPP capability report in response to obtaining (e.g., receiving), from the LMF 805-a, a request for the LPP capability report. In some cases, via the LPP capability report, the wireless device 810-a may output, to the wireless device 810-a, a capability message that includes an indication of one or more sensors associated with the wireless device 810-a, information associated with the one or more sensors, or both. In some examples, via the request for the LPP capability report, the LMF 805-a may request that the wireless device 810-a provide such capability message and the LMF 805-a may then output, to the wireless device 810-a, an indication of a configuration for the wireless device 810-a to collect and output one or more positioning measurements that include a combination of RF-based positioning measurements and visual-based positioning measurements, the configuration being in accordance with capabilities of the wireless device 810-a indicated via the capability message.

At 820, the wireless device 810-a may output (e.g., transmit), to the LMF 805-a, a report of RF-based positioning measurements, visual-based positioning measurements, a combination of both RF-based positioning measurements and visual-based positioning measurements, other positioning metadata, or any combination thereof. For example, the wireless device 810-a may output, to the LMF 805-a, one or more positioning measurements that are in accordance with the configuration obtained from the LMF 805-a. At 825, the LMF 805-a may then obtain (e.g., compute, generate, calculate) a positioning estimate and a confidence score for the positioning estimate based on the one or more positioning measurements. Additionally, or alternatively, the confidence score may also be referred to as an uncertainty computation.

At 830, the LMF 805-a may then output (e.g., transmit), to the wireless device 810-a, an inter-RAT measurement configuration as part of an RRC configuration to indicate one or more actions for the LMF 805-a to perform based on the positioning estimate and the confidence score for the positioning estimate. For example, the inter-RAT measurement configuration may include an indication for the wireless device 810-a to adapt a configuration utilized at the wireless device 810-a for collecting and outputting the one or more positioning measurements, an indication for the wireless device 810-a to adapt a power-saving mode, an indication for the wireless device 810-a to disable visual-based data collection, or any combination thereof based at least in part on the positioning estimate, the confidence score of the positioning estimate, or both. Therefore, some of the techniques of the present disclosure may be part of a positioning protocol procedure (e.g., an LPP procedure between an LMF 805-a and a wireless device 810-a). For example, for the process flow 800 may illustrate network-based positioning and positioning information may be output within a positioning protocol procedure and communications between a wireless device and a server may be in accordance with the positioning protocol procedure. Further descriptions of the techniques of the present disclosure may be described elsewhere herein, such as with reference to FIG. 8B and FIGS. 9 through 15.

FIG. 8B shows an example of a process flow 801 that supports energy efficient positioning procedures in accordance with one or more aspects of the present disclosure. In some examples, the process flow 801 may implement or be implemented by the wireless communications system 100, wireless communications system 400, or both. For example, the process flow 801 may include a LMF 805-b and a wireless device 810-b, which may be examples of devices described herein with reference to FIGS. 1 and 4.

In the following description of the process flow 801, the operations between the LMF 805-b and the wireless device 810-b may be performed in different orders or at different times. Some operations may also be left out of the process flow 801, or other operations may be added. Although the LMF 805-b and the wireless device 810-b are shown performing the operations of the process flow 801, some aspects of some operations may also be performed by one or more other wireless devices.

At 835, the wireless device 810-b may output (e.g., transmit), to the LMF 805-b, a LPP capability report. In some examples, the wireless device 810-b may output the LPP capability report in response to obtaining (e.g., receiving), from the LMF 805-b, a request for the LPP capability report. In some cases, via the LPP capability report, the wireless device 810-b may output, to the wireless device 810-b, a capability message that includes an indication of one or more sensors associated with the wireless device 810-b, information associated with the one or more sensors, or both. In some examples, via the request for the LPP capability report, the LMF 805-b may request that the wireless device 810-b provide such capability message and the LMF 805-b may then output, to the wireless device 810-b, an indication of a configuration for the wireless device 810-b to collect and output one or more positioning measurements that include a combination of RF-based positioning measurements and visual-based positioning measurements, the configuration being in accordance with capabilities of the wireless device 810-b indicated via the capability message.

At 840, the wireless device 810-b may obtain (e.g., compute, generate, calculate) a positioning estimate and a confidence score for the positioning estimate based on one or more positioning measurements in accordance with the configuration obtained at 835. Additionally, or alternatively, the confidence score may also be referred to as an uncertainty computation. At 845, the wireless device 810-b may then output (e.g., transmit), to the LMF 805-b, one or more positioning information reports that indicate the positioning estimate and confidence score obtained at 840. In some examples, the wireless device 810-b may output the one or more positioning information reports via LPP messages.

At 850, the LMF 805-b may then output (e.g., transmit), to the wireless device 810-b, an inter-RAT measurement configuration as part of an RRC configuration to indicate a subset of mapping information, one or more actions for the LMF 805-a to perform based on the positioning estimate and the confidence score for the positioning estimate, or both. For example, the inter-RAT measurement configuration may include an indication for the wireless device 810-a to adapt a configuration utilized at the wireless device 810-a for collecting and outputting the one or more positioning measurements, an indication for the wireless device 810-a to adapt a power-saving mode, an indication for the wireless device 810-a to disable visual-based data collection, or any combination thereof based at least in part on the positioning estimate, the confidence score of the positioning estimate, or both. In another example, as described elsewhere herein, such as with reference to FIG. 6, the LMF 805-b may obtain the positioning estimate and confidence score at 840 utilizing a first subset of mapping information. In such examples, the inter-RAT measurement configuration may indicate a second subset of mapping information based on at least one positioning information report within an LPP message indicating that the wireless device 810-b is at a boundary or edge of a map associated with the first subset of mapping information.

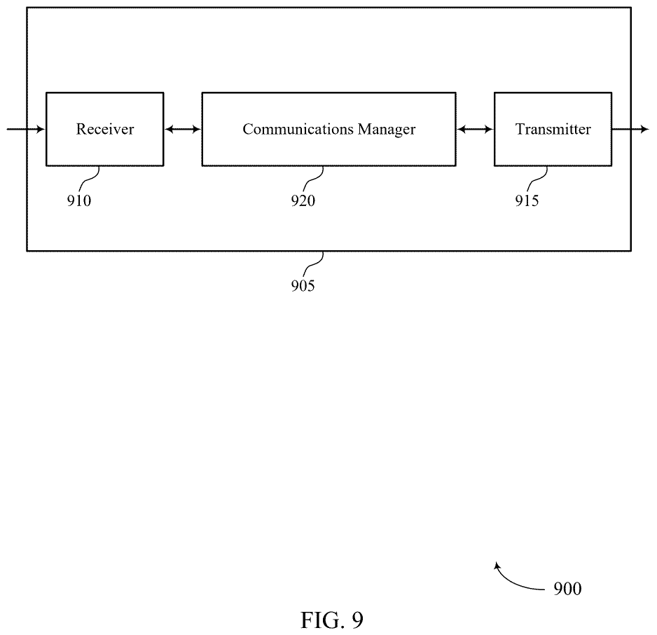

Therefore, some of the techniques of the present disclosure may be part of a positioning protocol procedure (e.g., an LPP procedure between an LMF 805-b and a wireless device 810-b). For example, for the process flow 801 may illustrate UE-based positioning and positioning information may be output within a positioning protocol procedure and communications between a wireless device and a server may be in accordance with the positioning protocol procedure. Further descriptions of the techniques of the present disclosure may be described elsewhere herein, such as with reference to FIGS. 9 through 15.

FIG. 9 shows a block diagram 900 of a device 905 that supports energy efficient positioning procedures in accordance with one or more aspects of the present disclosure. The device 905 may be an example of aspects of a wireless device as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to energy efficient positioning procedures). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to energy efficient positioning procedures). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations or components thereof may be examples of means for performing various aspects of energy efficient positioning procedures as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for outputting, to a server, positioning information associated with the wireless device within an environment, the positioning information being based on a combination of radio frequency data and visual data, where the radio frequency data and the visual data are associated with the environment. The communications manager 920 is capable of, configured to, or operable to support a means for communicating with the server in accordance with the positioning information that is based on the combination of both the radio frequency data and the visual data.

Additionally, or alternatively, the communications manager 920 may support wireless communications in accordance with examples as disclosed herein. For example, the communications manager 920 is capable of, configured to, or operable to support a means for outputting, to a server, a request for a first subset of mapping information of a set of mapping information associated with an environment, the set of mapping information including information associated with one or more portions of the environment, where the request includes an indication of positioning information associated with the wireless device within the environment. The communications manager 920 is capable of, configured to, or operable to support a means for obtaining, from the server and in response to the request, an indication of the first subset of mapping information. The communications manager 920 is capable of, configured to, or operable to support a means for outputting, to the server, one or more positioning information reports associated with the first subset of mapping information. The communications manager 920 is capable of, configured to, or operable to support a means for obtaining, from the server, an indication of a second subset of mapping information based on at least one positioning information report of the one or more positioning information reports.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for wireless devices to communicate RF-based positioning information, visual-based positioning information, or both with servers to support reduced processing, reduced power consumption, and more efficient utilization of communication resources.

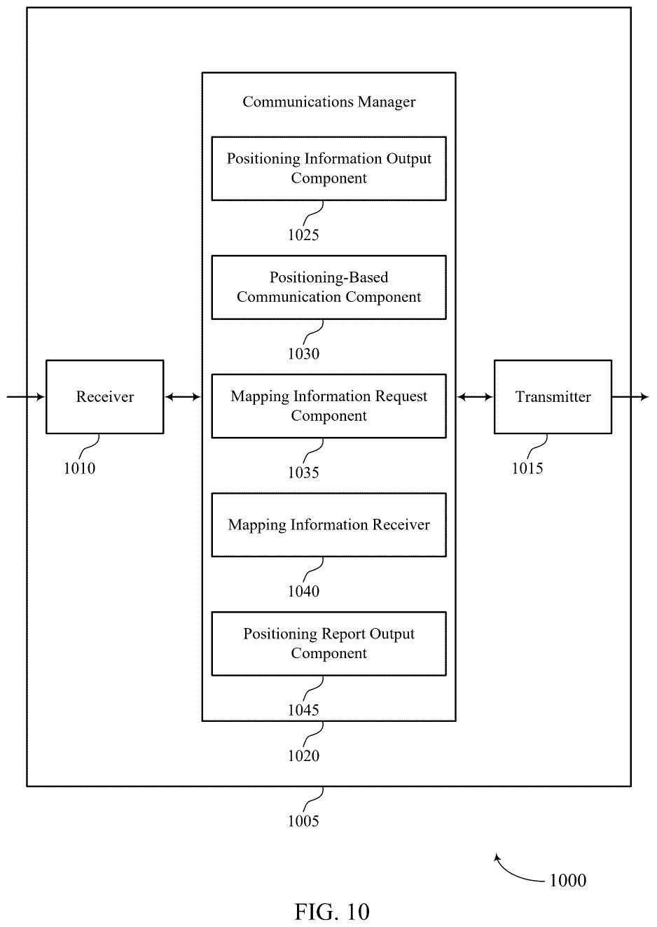

FIG. 10 shows a block diagram 1000 of a device 1005 that supports energy efficient positioning procedures in accordance with one or more aspects of the present disclosure. The device 1005 may be an example of aspects of a device 905 or a wireless device as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to energy efficient positioning procedures). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to energy efficient positioning procedures). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of energy efficient positioning procedures as described herein. For example, the communications manager 1020 may include a positioning information output component 1025, a positioning-based communication component 1030, a mapping information request component 1035, a mapping information receiver 1040, a positioning report output component 1045, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The positioning information output component 1025 is capable of, configured to, or operable to support a means for outputting, to a server, positioning information associated with the wireless device within an environment, the positioning information being based on a combination of radio frequency data and visual data, where the radio frequency data and the visual data are associated with the environment. The positioning-based communication component 1030 is capable of, configured to, or operable to support a means for communicating with the server in accordance with the positioning information that is based on the combination of both the radio frequency data and the visual data.

Additionally, or alternatively, the communications manager 1020 may support wireless communications in accordance with examples as disclosed herein. The mapping information request component 1035 is capable of, configured to, or operable to support a means for outputting, to a server, a request for a first subset of mapping information of a set of mapping information associated with an environment, the set of mapping information including information associated with one or more portions of the environment, where the request includes an indication of positioning information associated with the wireless device within the environment. The mapping information receiver 1040 is capable of, configured to, or operable to support a means for obtaining, from the server and in response to the request, an indication of the first subset of mapping information. The positioning report output component 1045 is capable of, configured to, or operable to support a means for outputting, to the server, one or more positioning information reports associated with the first subset of mapping information. The mapping information receiver 1040 is capable of, configured to, or operable to support a means for obtaining, from the server, an indication of a second subset of mapping information based on at least one positioning information report of the one or more positioning information reports.

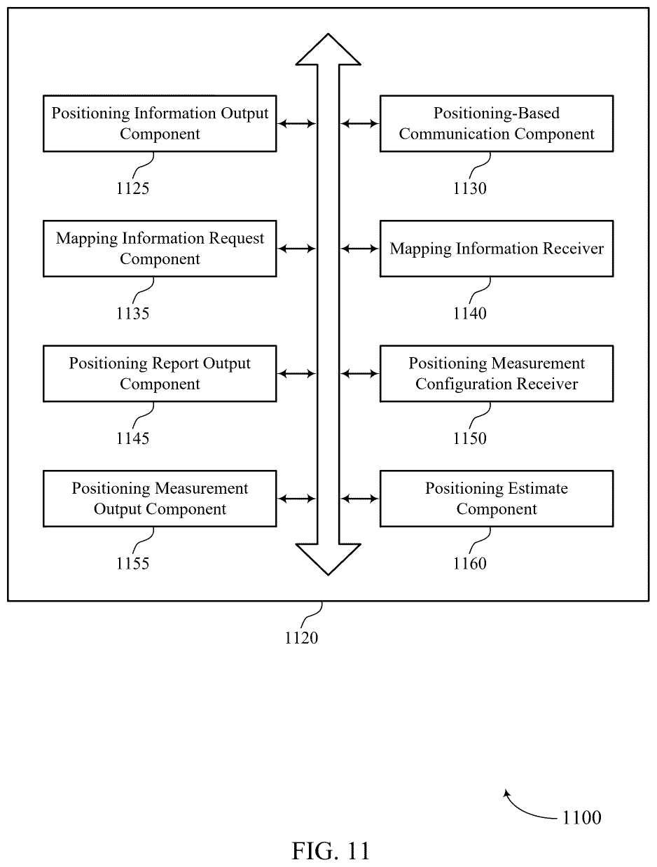

FIG. 11 shows a block diagram 1100 of a communications manager 1120 that supports energy efficient positioning procedures in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of energy efficient positioning procedures as described herein. For example, the communications manager 1120 may include a positioning information output component 1125, a positioning-based communication component 1130, a mapping information request component 1135, a mapping information receiver 1140, a positioning report output component 1145, a positioning measurement configuration receiver 1150, a positioning measurement output component 1155, a positioning estimate component 1160, or any combination thereof. Each of these components, or components or subcomponents thereof (e.g., one or more processors, one or more memories), may communicate, directly or indirectly, with one another (e.g., via one or more buses).

The communications manager 1120 may support wireless communications in accordance with examples as disclosed herein. The positioning information output component 1125 is capable of, configured to, or operable to support a means for outputting, to a server, positioning information associated with the wireless device within an environment, the positioning information being based on a combination of radio frequency data and visual data, where the radio frequency data and the visual data are associated with the environment. The positioning-based communication component 1130 is capable of, configured to, or operable to support a means for communicating with the server in accordance with the positioning information that is based on the combination of both the radio frequency data and the visual data.

In some examples, to support outputting the positioning information, the positioning information output component 1125 is capable of, configured to, or operable to support a means for outputting, to the server, a request for a positioning estimate of the wireless device, the positioning estimate indicating a location of the wireless device within the environment. In some examples, to support outputting the positioning information, the positioning information output component 1125 is capable of, configured to, or operable to support a means for outputting, to the server in conjunction with the request for the positioning estimate, a capability message including an indication of one or more sensors associated with the wireless device, information associated with the one or more sensors, or both, where the positioning information includes the request for the positioning estimate and the capability message.

In some examples, the positioning measurement configuration receiver 1150 is capable of, configured to, or operable to support a means for obtaining, from the server, an indication of a configuration for the wireless device to collect and output one or more positioning measurements that include a combination of radio frequency-based positioning measurements and visual-based positioning measurements, the configuration being in accordance with capabilities of the wireless device indicated via the capability message. In some examples, the positioning measurement output component 1155 is capable of, configured to, or operable to support a means for outputting, to the server, the one or more positioning measurements in accordance with the configuration. In some examples, the positioning estimate component 1160 is capable of, configured to, or operable to support a means for obtaining, from the server, the positioning estimate and a confidence score associated with the positioning estimate, the positioning estimate being based on the one or more positioning measurements.

In some examples, to support communicating with the server in accordance with the positioning information, the positioning-based communication component 1130 is capable of, configured to, or operable to support a means for obtaining, from the server, an indication to adapt the configuration for the wireless device to collect and output the one or more positioning measurements, an indication to adapt a power-saving mode of the wireless device, an indication to disable visual-based data collection, or any combination thereof based on the positioning estimate, the confidence score of the positioning estimate, or both.

In some examples, the one or more positioning measurements are output in accordance with a periodicity.

In some examples, the mapping information request component 1135 is capable of, configured to, or operable to support a means for outputting, to the server, a request for a first subset of mapping information of a set of mapping information associated with the environment in conjunction with outputting the positioning information, the set of mapping information including information associated with one or more portions of the environment, where the positioning information includes an indication of a position of the wireless device within the environment that is based on the combination of the radio frequency data and the visual data. In some examples, the mapping information receiver 1140 is capable of, configured to, or operable to support a means for obtaining, from the server and in response to the request for the first subset of mapping information, an indication of the first subset of mapping information.

In some examples, the positioning report output component 1145 is capable of, configured to, or operable to support a means for outputting, to the server, one or more positioning information reports that are based on the combination of the radio frequency data and the visual data, the one or more positioning information reports being associated with the first subset of mapping information based on obtaining the indication of the first subset of mapping information. In some examples, the mapping information receiver 1140 is capable of, configured to, or operable to support a means for obtaining, from the server, an indication of a second subset of mapping information based on at least one positioning information report of the one or more positioning information reports of the positioning information.

In some examples, the at least one positioning information report indicates that the wireless device is at a boundary of a respective portion of the environment of the one or more portions of the environment that is associated with the first subset of mapping information.

In some examples, the one or more positioning information reports are output in accordance with a periodicity.

In some examples, to support communicating with the server in accordance with the positioning information, the positioning-based communication component 1130 is capable of, configured to, or operable to support a means for obtaining, from the server, an indication to perform radio frequency-based positioning procedures, to perform visual-based positioning procedures, or both to obtain a respective positioning estimate and a respective confidence score associated with the respective positioning estimate.

In some examples, obtaining the indication is based on whether the respective confidence score associated with the respective positioning estimate satisfies a confidence threshold, an iteration quantity threshold, or both.

In some examples, the positioning information is output within a positioning protocol procedure and communications with the server are in accordance with the positioning protocol procedure.

Additionally, or alternatively, the communications manager 1120 may support wireless communications in accordance with examples as disclosed herein. The mapping information request component 1135 is capable of, configured to, or operable to support a means for outputting, to a server, a request for a first subset of mapping information of a set of mapping information associated with an environment, the set of mapping information including information associated with one or more portions of the environment, where the request includes an indication of positioning information associated with the wireless device within the environment. The mapping information receiver 1140 is capable of, configured to, or operable to support a means for obtaining, from the server and in response to the request, an indication of the first subset of mapping information. The positioning report output component 1145 is capable of, configured to, or operable to support a means for outputting, to the server, one or more positioning information reports associated with the first subset of mapping information. In some examples, the mapping information receiver 1140 is capable of, configured to, or operable to support a means for obtaining, from the server, an indication of a second subset of mapping information based on at least one positioning information report of the one or more positioning information reports.

In some examples, the at least one positioning information report indicates that the wireless device is at a boundary of a respective portion of the environment of the one or more portions of the environment that is associated with the first subset of mapping information.

In some examples, the one or more positioning information reports are output in accordance with a periodicity.

In some examples, positioning information associated with the wireless device within the environment and the one or more positioning information reports are associated with radio frequency data, visual data, or any combination thereof.

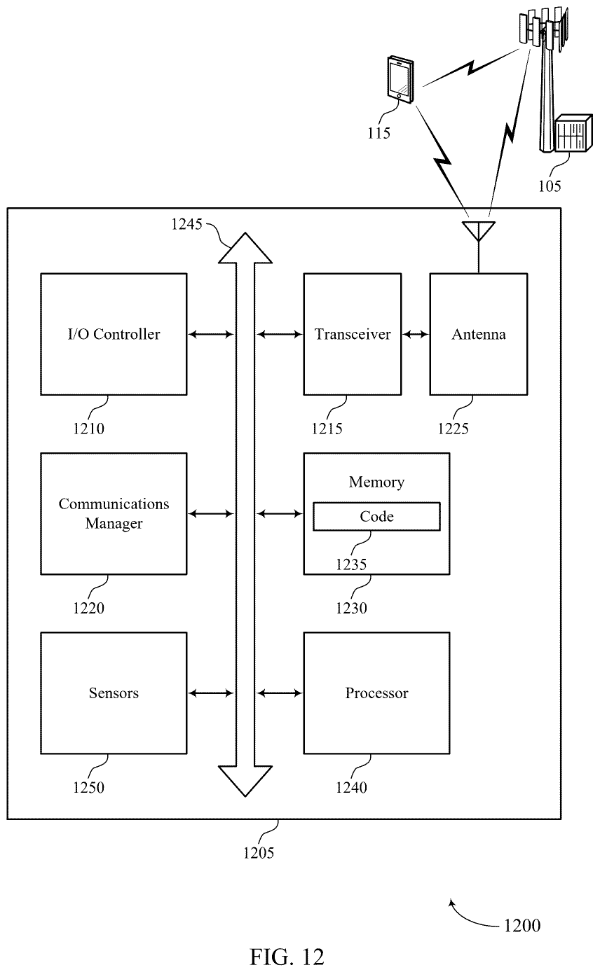

FIG. 12 shows a diagram of a system 1200 including a device 1205 that supports energy efficient positioning procedures in accordance with one or more aspects of the present disclosure. The device 1205 may include components for bi-directional voice and data communications including components for transmitting and receiving communications, such as a communications manager 1220, an I/O controller, such as an I/O controller 1210, one or more transceivers 1215, one or more antennas 1225, at least one memory 1230, code 1235, and at least one processor 1240. The device 1205 may include one or more sensors 1250. These components may be in electronic communication or otherwise coupled (e.g., operatively, communicatively, functionally, electronically, electrically) via one or more buses (e.g., a bus 1245). The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna. However, in some other cases, the device 1205 may have more than one antenna, which may be capable of concurrently transmitting or receiving multiple wireless transmissions. The transceiver(s) 1215 may communicate bi-directionally via the one or more antennas 1225 using wired or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The one or more transceivers 1215 may include one or more wireless wide area network (WWAN) transceivers, one or more short-range wireless transceivers, or one or more satellite transceivers. The WWAN transceiver(s) may communicate with (e.g., transmit one or more signals to, or receive one or more signals from) one or more wireless communication networks, such as an NR network, an LTE network, or a GSM network, among other examples. The WWAN transceiver(s) may be connected to one or more of the antenna(s) 1225 for communicating with other devices, such as one or more UEs 115, network nodes 105, access points, base stations (e.g., eNBs, gNBs), or another device(s), via at least one RAT (e.g., NR, LTE, or GSM, among other examples) over a wireless communication medium (e.g., time or frequency resources of a frequency spectrum). The WWAN transceiver(s) may be configured for transmitting and encoding signals (e.g., messages, indications, or information, among other examples) or for receiving and decoding signals (e.g., messages, indications, information, or pilots, among other examples), in accordance with the RAT. For instance, the WWAN transceiver(s) may include one or more transmitters for transmitting and encoding signals, or one or more receivers for receiving and decoding signals.

The short-range wireless transceivers may be connected to one or more of the antenna(s) 1225 to communicate with (e.g., transmit one or more signals to, or receive one or more signals from) one or more network entities, such as one or more UEs 115, network nodes 105, access points, base stations, or another device(s), via at least one RAT (e.g., Wi-Fi, LTE Direct, BLUETOOTH®, ZIGBEE®, Z-WAVE®, PC5, dedicated short-range communications (DSRC), wireless access for vehicular environments (WAVE), near-field communication (NFC), or ultra-wideband (UWB), among other examples) over a wireless communication medium. The short-range wireless transceiver(s) may be configured for transmitting and encoding signals (e.g., messages, indications, or information, among other examples), or for receiving and decoding signals (e.g., messages, indications, information, or pilots, among other examples), in accordance with the RAT. For instance, the short-range wireless transceiver(s) may include one or more transmitters for transmitting and encoding signals, or one or more receivers for receiving and decoding signals. In some examples, the short-range wireless transceiver(s) may be one or more Wi-Fi transceivers, BLUETOOTH® transceivers, ZIGBEE® transceivers, Z-WAVE® transceivers, NFC transceivers, UWB transceivers, vehicle-to-vehicle (V2V) transceivers, or vehicle-to-everything (V2X) transceivers, among other examples.

The satellite transceiver(s) may include one or more satellite signal receivers, or one or more satellite signal transmitters. In some cases, the device 1205 may be a terrestrial device that may communicate one or more satellites via the satellite transceiver(s). In other cases, device 1205 may be a satellite (or other non-terrestrial entity) that uses the satellite transceiver(s) to communicate with one or more terrestrial networks or other satellites.

The satellite signal receiver(s) may be connected to one or more of the antenna(s) 1225 for receiving or measuring satellite positioning or communication signals. In some examples, the satellite signal receiver(s) may include one or more satellite positioning system receivers, where the satellite positioning or communication signals may be GPS signals, GLONASS signals, Galileo signals, BeiDou signals, Indian Regional Navigation Satellite System (NAVIC), or Quasi-Zenith Satellite System (QZSS) signals, among other examples. In some examples, the satellite signal receiver(s) may include one or more NTN receivers, where the satellite positioning or communication signals may be communication signals (e.g., carrying control or user data) originating from a device or network. The satellite signal receiver(s) may include hardware or a combination of hardware and instructions for receiving and processing satellite positioning or communication signals. The satellite signal receiver(s) or the processor 1240 may perform calculations to determine a location of the device 1205, the UE 115, the network node 105, or another device using measurements obtained from one or more satellite signals.

The one or more satellite signal transmitters may be connected to one or more of the antennas 1225 for transmitting satellite positioning communication signals. In some examples, the satellite signal transmitter(s) may be satellite positioning system transmitters, and the satellite positioning or communication signals may be GPS signals, GLONASS® signals, Galileo signals, BeiDou signals, NAVIC, or QZSS signals, among other examples. In some examples, the satellite signal transmitter(s) include one or more NTN transmitters, and the satellite positioning or communication signals may be communication signals (e.g., carrying control or user data). The satellite signal transmitter(s) may comprise hardware or a combination of hardware and instructions for transmitting satellite positioning or communication signals.

The device 1205 may include one or more sensors 1250 coupled with the one or more processors 1240 for obtaining sensor data (e.g., image data, RF data, motion data, orientation data, or audio data, among other examples). For example, the one or more sensors 1250 may sense or detect movement or orientation information. In some aspects, the movement or orientation information may be independent from motion data derived from signals received by the one or more WWAN transceivers, the one or more short-range wireless transceivers, or the satellite signal interface. In some examples, the sensor(s) 1250 may include an accelerometer (e.g., a micro-electrical mechanical systems (MEMS) device), a gyroscope, a geomagnetic sensor (e.g., a compass), an altimeter (e.g., a barometric pressure altimeter), or any other type of movement detection sensor. Additionally, or alternatively, the one or more sensors 1250 may include an image sensor, camera, microphone, light detector, or pressure sensor, among other examples. In some aspects, the sensor(s) 1250 may include a plurality of different types of devices, and the device 1205 (e.g., sensor(s) 1250 or processor(s) 1240) may combine the outputs of the different types of devices to provide motion information. For example, the sensor(s) 1250 may use a combination of a multi-axis accelerometer sensors, orientation sensors, or image sensors to provide the ability to compute positions in two-dimensional (2D) or three-dimensional (3D) coordinate systems.

The at least one memory 1230 may include RAM and ROM. The at least one memory 1230 may store computer-readable, computer-executable, or processor-executable code, such as the code 1235. The code 1235 may include instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may include, among other things, a BIOS which may control basic hardware or software operation such as the interaction with peripheral components or devices.

The at least one processor 1240 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting channel estimation based on time domain signals) For example, the device 1205 or a component of the device 1205 may include at least one processor 1240 and at least one memory 1230 coupled with or to the at least one processor 1240, the at least one processor 1240 and the at least one memory 1230 configured to perform various functions described herein.

In some examples, the at least one processor 1240 may include multiple processors and the at least one memory 1230 may include multiple memories. One or more of the multiple processors may be coupled with one or more of the multiple memories, which may, individually or collectively, be configured to perform various functions described herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. For example, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code 1235 (e.g., processor-executable code) stored in the at least one memory 1230 or otherwise, to perform one or more of the functions described herein.

The communications manager 1220 may support wireless communications in accordance with examples as disclosed herein. For example, the communications manager 1220 is capable of, configured to, or operable to support a means for outputting, to a server, positioning information associated with the wireless device within an environment, the positioning information being based on a combination of radio frequency data and visual data, where the radio frequency data and the visual data are associated with the environment. The communications manager 1220 is capable of, configured to, or operable to support a means for communicating with the server in accordance with the positioning information that is based on the combination of both the radio frequency data and the visual data.

Additionally, or alternatively, the communications manager 1220 may support wireless communications in accordance with examples as disclosed herein. For example, the communications manager 1220 is capable of, configured to, or operable to support a means for outputting, to a server, a request for a first subset of mapping information of a set of mapping information associated with an environment, the set of mapping information including information associated with one or more portions of the environment, where the request includes an indication of positioning information associated with the wireless device within the environment. The communications manager 1220 is capable of, configured to, or operable to support a means for obtaining, from the server and in response to the request, an indication of the first subset of mapping information. The communications manager 1220 is capable of, configured to, or operable to support a means for outputting, to the server, one or more positioning information reports associated with the first subset of mapping information. The communications manager 1220 is capable of, configured to, or operable to support a means for obtaining, from the server, an indication of a second subset of mapping information based on at least one positioning information report of the one or more positioning information reports.

By including or configuring the communications manager 1220 in accordance with examples as described herein, the device 1205 may support techniques for wireless devices to communicate RF-based positioning information, visual-based positioning information, or both with servers to support improved communication reliability, reduced latency, improved user experience related to reduced processing, reduced power consumption, more efficient utilization of communication resources, improved coordination between devices, longer battery life, and improved utilization of processing capability.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of energy efficient positioning procedures as described herein, or the at least one processor 1240 and the at least one memory 1230 may be otherwise configured to, individually or collectively, perform or support such operations.

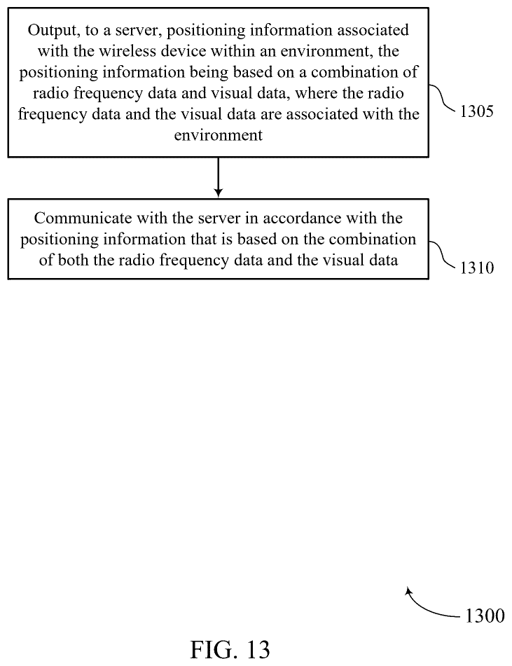

FIG. 13 shows a flowchart illustrating a method 1300 that supports energy efficient positioning procedures in accordance with one or more aspects of the present disclosure. The operations of the method 1300 may be implemented by a wireless device or its components as described herein. For example, the operations of the method 1300 may be performed by a wireless device as described with reference to FIGS. 1 through 12. In some examples, a wireless device may execute a set of instructions to control the functional elements of the wireless device to perform the described functions. Additionally, or alternatively, the wireless device may perform aspects of the described functions using special-purpose hardware.

At 1305, the method may include outputting, to a server, positioning information associated with the wireless device within an environment, the positioning information being based on a combination of radio frequency data and visual data, where the radio frequency data and the visual data are associated with the environment. The operations of 1305 may be performed in accordance with examples as disclosed herein. In some examples, aspects of the operations of 1305 may be performed by a positioning information output component 1125 as described with reference to FIG. 11.

At 1310, the method may include communicating with the server in accordance with the positioning information that is based on the combination of both the radio frequency data and the visual data. The operations of 1310 may be performed in accordance with examples as disclosed herein. In some examples, aspects of the operations of 1310 may be performed by a positioning-based communication component 1130 as described with reference to FIG. 11.

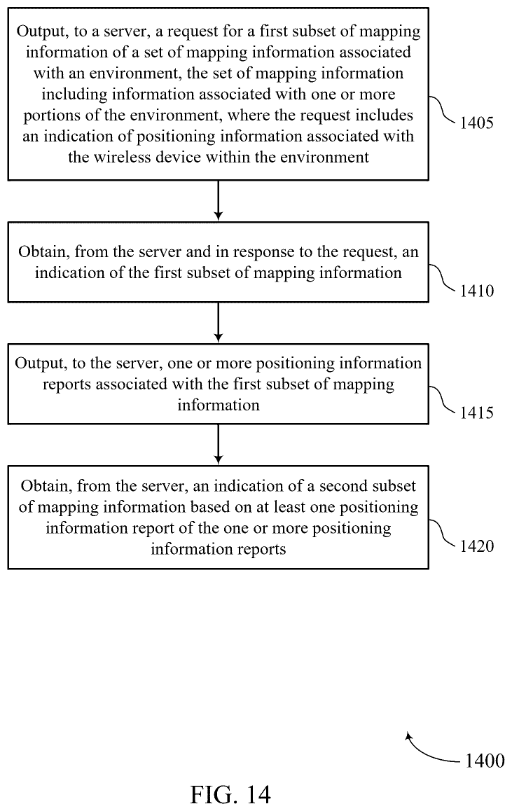

FIG. 14 shows a flowchart illustrating a method 1400 that supports energy efficient positioning procedures in accordance with one or more aspects of the present disclosure. The operations of the method 1400 may be implemented by a wireless device or its components as described herein. For example, the operations of the method 1400 may be performed by a wireless device as described with reference to FIGS. 1 through 12. In some examples, a wireless device may execute a set of instructions to control the functional elements of the wireless device to perform the described functions. Additionally, or alternatively, the wireless device may perform aspects of the described functions using special-purpose hardware.

At 1405, the method may include outputting, to a server, a request for a first subset of mapping information of a set of mapping information associated with an environment, the set of mapping information including information associated with one or more portions of the environment, where the request includes an indication of positioning information associated with the wireless device within the environment. The operations of 1405 may be performed in accordance with examples as disclosed herein. In some examples, aspects of the operations of 1405 may be performed by a mapping information request component 1135 as described with reference to FIG. 11.

At 1410, the method may include obtaining, from the server and in response to the request, an indication of the first subset of mapping information. The operations of 1410 may be performed in accordance with examples as disclosed herein. In some examples, aspects of the operations of 1410 may be performed by a mapping information receiver 1140 as described with reference to FIG. 11.

At 1415, the method may include outputting, to the server, one or more positioning information reports associated with the first subset of mapping information. The operations of 1415 may be performed in accordance with examples as disclosed herein. In some examples, aspects of the operations of 1415 may be performed by a positioning report output component 1145 as described with reference to FIG. 11.

At 1420, the method may include obtaining, from the server, an indication of a second subset of mapping information based on at least one positioning information report of the one or more positioning information reports. The operations of 1420 may be performed in accordance with examples as disclosed herein. In some examples, aspects of the operations of 1420 may be performed by a mapping information receiver 1140 as described with reference to FIG. 11.

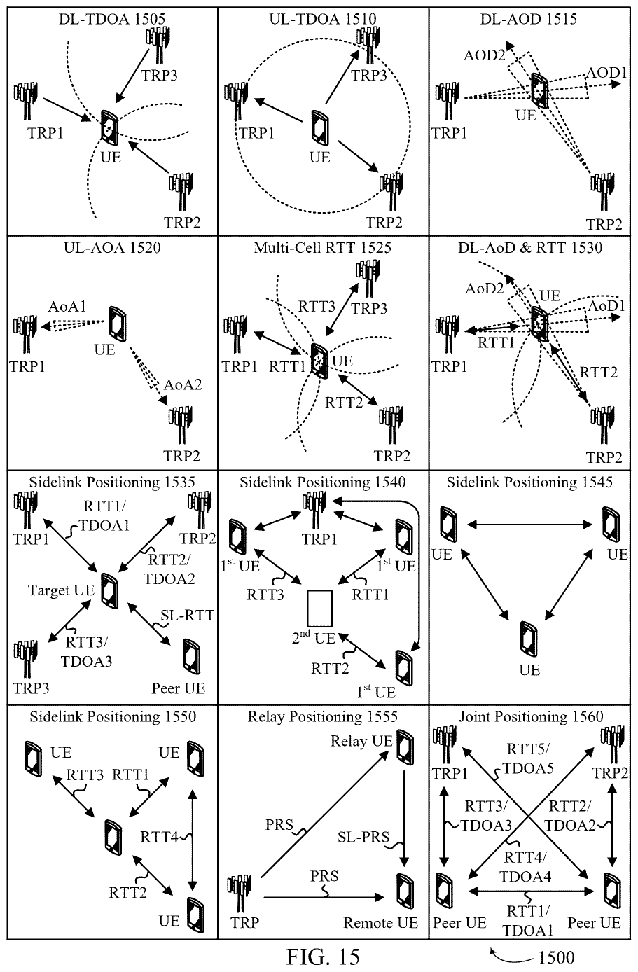

FIG. 15 shows examples of wireless communications systems 1500 that supports energy efficient positioning procedures in accordance with one or more aspects of the present disclosure. Various positioning techniques are illustrated in the context of the wireless communications systems 1500. Some examples of the positioning procedures described herein may be performed in accordance with one or more aspects of the positioning techniques. While TRPs and UEs are provided in the examples illustrated in FIG. 15, other devices (e.g., network entities, base stations, RRHs, RUs, APs, wireless devices, or stations, among other examples) may be similarly utilized in other examples. The examples of positioning techniques include downlink-based positioning techniques, uplink-based positioning techniques, and downlink-and-uplink-based positioning techniques.

Examples of OTDOA or DL-TDOA 1505 are illustrated in FIG. 15. One or more of the OTDOA or DL-TDOA 1505 positioning techniques may be included in a downlink-based positioning procedure. In OTDOA or DL-TDOA 1505 positioning techniques, a UE may measure a difference between TOAs of reference signals (e.g., PRSs) received from one or more pairs of TRPs (e.g., TRP2 and TRP3). In some approaches, a difference in TOAs may be referred to as an RSTD or a TDOA measurement. A positioning device (e.g., the UE, a location server, an LMF, an SLP, or another device) may utilize the differences in TOAs to determine (e.g., estimate) a location of the UE.

In some aspects, the UE may receive an identifier (ID) associated with a reference TRP (e.g., a serving base station) and one or more IDs associated with one or more non-reference TRPs in received data (e.g., assistance data). The UE may measure the difference of TOAs between the reference TRP and each of the non-reference TRPs to produce RSTDs or TDOAs. In some aspects, the UE may report an indication of the RSTDs or TDOAs to the positioning device (e.g., a location server, LMF, an SLP, or another device). Based on established locations of the base stations and the RSTD measurements, the positioning device (e.g., the UE for UE-based positioning or a location server for UE-assisted positioning) may estimate the UE's location.

An example of UL-TDOA 1510 is illustrated in FIG. 15. One or more of the UL-TDOA 1510 positioning techniques may be included in an uplink-based positioning procedure. UL-TDOA 1510 may have some similarities to DL-TDOA 1505. The UL-TDOA 1510 positioning techniques may be based on uplink reference signals (e.g., SRS) transmitted from the UE to multiple TRPs. For example, the UE transmits one or more uplink reference signals that are measured by a reference TRP (e.g., TRP3) and non-reference TRPs (e.g., TRP1 and TRP2). Each TRP then reports the reception time (which may be referred to as a relative time of arrival (RTOA)) of the reference signal(s) to a positioning device (e.g., a location server, LMF, SLP, or UE) that has information about the locations and relative timing of the TRPs. Based on the reception-to-reception (Rx-Rx) time differences between the reported RTOA of the reference TRP and the reported RTOA of each non-reference TRP, the locations of the TRPs, and the corresponding timing offsets, the positioning device may estimate the location of the UE using TDOA.

An example of DL-AOD 1515 is illustrated in FIG. 15. One or more of the DL-AOD 1515 positioning techniques may be included in a downlink-based positioning procedure. In DL-AOD 1515, a UE may obtain received signal strength measurements corresponding to multiple downlink transmit beams for one or more TRPs (e.g., TRP1 and TRP2). In some approaches, the UE reports the measurements to a positioning device. The positioning device may use the signal strength measurements of the multiple downlink transmit beams to determine the angle(s) (e.g., AOD1 and AOD2) between the UE and the transmitting TRP(s). The positioning device (e.g., location server, LMF, SLP, UE, or another device) may estimate the location of the UE based on the determined angle(s) and the established location(s) of the transmitting TRP(s).

An example of UL-AOA 1520 is illustrated in FIG. 15. One or more of the UL-AOA 1520 positioning techniques may be included in an uplink positioning procedure. In UL-AOA 1520, one or more TRPs (e.g., TRP1 and TRP2) measure the received signal strength of one or more uplink reference signals (e.g., SRSs) received from a UE on one or more uplink receive beams. In some aspects, the signal strength measurements may be reported to a positioning device. A positioning device (e.g., LFM, SLP, UE, or another device) may use the signal strength measurements and the angle(s) of the receive beam(s) to determine the angle(s) between the UE and the TRP(s). Based on the determined angle(s) and the established location(s) of the TRP(s), the positioning device may estimate the location of the UE.

Some positioning techniques or procedures may include a combination downlink-based and uplink-based positioning techniques. Examples of downlink-based and uplink-based positioning techniques may include E-CID positioning and mRTT positioning (which may be referred to as “multi-RTT” or “multi-cell RTT” when multiple cells are utilized).

In multi-RTT, a first device (e.g., a TRP or UE) may transmit a first RTT-related signal (e.g., a PRS or SRS) to a second device (e.g., the UE or TRP). The second device may transmit a second RTT-related signal (e.g., an SRS or PRS) back to the first device. Each device may measure a time difference between the TOA of the received RTT-related signal and the transmission time of the transmitted RTT-related signal. The time difference may be referred to as a reception-to-transmission (Rx-Tx) time difference. In some aspects, the Rx-Tx time difference measurement may be obtained or adjusted to include (e.g., include only) a time difference between nearest slot boundaries for the received and transmitted signals. The first device or the second device may send the corresponding Rx-Tx time difference measurements to a positioning device (e.g., a location server, LMF, SLP, UE, or other device), which may calculate a round trip propagation time (or RTT) between the two device based on the two Rx-Tx time difference measurements (e.g., as a sum of the two Rx-Tx time difference measurements). Additionally, or alternatively, one device may send a corresponding Rx-Tx time difference measurement to the other device, which may calculate the RTT. The distance between the two devices may be determined from the RTT and a signal speed (e.g., the speed of light).

An example of multi-cell RTT 1525 is illustrated in FIG. 15. One or more of the multi-RTT or multi-cell RTT techniques described may be included in an uplink-based or downlink-based positioning procedure. In multi-cell RTT 1525, a first device (e.g., a UE or TRP) may perform an RTT positioning procedure with multiple second devices (e.g., multiple TRPs or UEs) to enable the location of the first device to be determined (e.g., using multilateration) based on distances to, and the established locations of, the second devices.

In some examples, RTT or multi-RTT techniques may be combined with one or more other positioning techniques (e.g., UL-AOA, DL-AOD, or other positioning techniques), to enhance location accuracy. Examples of combined DL-AOD and RTT 1530 positioning techniques are illustrated in FIG. 15.

E-CID positioning techniques may be based on radio resource management (RRM) measurements. In E-CID, a UE may obtain or report a serving cell ID, a timing advance (TA), identifiers of one or more detected neighbor TRPs, estimated timing of one or more detected neighbor TRPs, or a signal strength measurement of one or more detected neighbor TRPs. A positioning device (e.g., an LFM, SLP, UE, or another device) may utilize the serving cell ID, TA, identifiers, estimated timing, or signal strength measurements with one or more established locations of one or more TRPs to estimate the location of the UE.

In some approaches, a positioning device (e.g., location server, LMF, SLP, or another device) may provide assistance data to the UE. Assistance data is data to assist with one or more positioning operations (e.g., to detect one or more neighboring TRPs or to receive reference signaling). For instance, the assistance data may indicate IDs of the TRPs (e.g., IDs of one or more cells or TRPs corresponding to a network node) from which reference signals may be measured. In some examples, a positioning device may transmit assistance data or other information indicating one or more reference signal configuration parameters. The reference signal configuration parameter(s) may include or indicate a quantity of consecutive slots including PRS, a periodicity of consecutive slots including PRS, a muting sequence, a frequency hopping sequence, a reference signal identifier, a reference signal bandwidth, or one or more other parameters applicable to a positioning technique or procedure. Additionally, or alternatively, the assistance data may be sent from one or more TRPs (e.g., in periodically broadcasted overhead messages, a scheduled message, a unicast message, or a multicast message, among other examples). In some examples, a UE may be able to detect one or more neighboring TRPs (e.g., network entities) without the use of assistance data.

For OTDOA positioning techniques or DL-TDOA positioning techniques, the assistance data may indicate an expected RSTD value and an associated uncertainty or search window around the expected RSTD. For example, an expected RSTD value may have an associated uncertainty or search window with a range of ±500 microseconds (μs). In another example, when any of the resources used for the positioning measurement(s) are in frequency range 1 (FR1), an expected RSTD value may have an associated uncertainty or search window with a range of ±32 μs. In another example, when all of the resources used for the positioning measurement(s) are in frequency range 2 (FR2), an expected RSTD value may have an associated uncertainty or search window with a range of ±8 μs.

In some examples, a location may be referred to as a position estimate, location estimate, position, position fix, or fix, among other examples. A location may be geodetic and include coordinates (e.g., latitude, longitude, or altitude) or may be civic and include a street address, postal address, or another description of a location. In some aspects, a location may be defined relative to another location or may be defined in absolute terms (e.g., latitude, longitude, or altitude). A location may include an indication of error or uncertainty (e.g., by including an area or volume within which the location may be included with a specified or default level of confidence).

Various examples of sidelink positioning techniques are illustrated in FIG. 15. Sidelink positioning techniques may include positioning techniques that are based on sidelink communication (e.g., based exclusively on sidelink communication or based on sidelink communication jointly with other communication(s), such as Uu interface communication).

A first example of sidelink positioning 1535 is illustrated in FIG. 15. In the first example of sidelink positioning 1535, at least one peer UE with an established location may improve location estimation (e.g., Uu-based positioning, multi-cell RTT, DL-TDOA, or UL-TDOA, among other examples) for a target UE by providing an additional anchor (e.g., sidelink RTT (SL-RTT)).

A second example of sidelink positioning 1540 is illustrated in FIG. 15. In the second example of sidelink positioning 1540, different types (e.g., categories, classes, or capabilities) of UEs may be utilized. For example, first UEs and a second UE may be utilized. Relative to the second UE, the first UEs may have one or more increased capabilities, such as one or more additional sensors, a faster processor, greater memory capacity, one or more additional antenna elements, a higher transmit power capability, access to one or more additional frequency bands, or any combination thereof. In some aspects, the second UE may be a reduced capacity or “RedCap” UE. The second UE may be assisted by the first UEs to determine the location of the second UE. For instance, sidelink-based positioning or ranging procedures may be performed with the first UEs, which may enhance the location accuracy of the second UE.

A third example of sidelink positioning 1545 is illustrated in FIG. 15. The third example of sidelink positioning 1545 may be performed via one or more sidelink connections (e.g., via sidelink connections exclusively or jointly with one or more Uu-based connections). In the third example of sidelink positioning 1545, the UEs may perform peer-to-peer (P2P) positioning or ranging. Sidelink positioning may be helpful for out-of-coverage or public safety scenarios. For instance, the UEs may be out of coverage of a network and may determine a location or a relative distance and a relative position among the UEs using sidelink positioning techniques. In some examples, sidelink positioning may be performed by UEs in public safety scenarios (e.g., for police, firefighters, search-and-rescue, or paramedics, among other examples).

A fourth example of sidelink positioning 1550 is illustrated in FIG. 15. The fourth example of sidelink positioning 1550 may be performed via one or more sidelink connections (e.g., via sidelink connections exclusively or jointly with one or more Uu-based connections). In the fourth example of sidelink positioning 1550, one or more of the UEs may determine a location or a relative distance and a relative position using sidelink positioning techniques, such as SL-RTT. For instance, one or more of the UEs may be out of coverage of a network and may determine a location or a relative distance and a relative position among the UEs using sidelink positioning techniques.

An example of relay positioning 1555 is illustrated in FIG. 15. In the example of relay positioning 1555, a relay UE (e.g., with an established location) may participate in the location estimation of a remote UE (without performing uplink reference signal transmission over the Uu interface, for instance). For example, the relay UE may receive a downlink PRS from a TRP and may relay an SL-PRS to the remote UE. In some cases, the remote UE may also receive another downlink PRS from the TRP. A positioning device (e.g., location server, LMF, SLP, UE, or other device) may utilize a downlink PRS measurement and an SL-PRS measurement with the established location of the relay UE to estimate the location of the remote UE.

An example of joint positioning 1560 is illustrated in FIG. 15. In the example of joint positioning 1560, multiple peer UEs (without established locations, for instance) may be located. In some approaches, multiple peer UEs may be jointly located in NLOS conditions by utilizing one or more constraints from one or more peer (e.g., neighboring or nearby) UEs. As illustrated in FIG. 15, RTT or TDOA techniques may be performed between TRP1 and each of the peer UEs, may be performed between TRP2 and each of the peer UEs, and may be performed between the peer UEs. In some examples, one or more of the peer UEs may report measurements from the RTT or TDOA technique(s) to a positioning device. The positioning device (e.g., location server, LMF, SLP, UE, or other device) may utilize the measurements from the RTT or TDOA technique(s) to estimate the locations of the peer UEs.

In some examples, the wireless communications systems 1500 may utilize some of the techniques of the present disclosure. For example, in accordance with the techniques of the present disclosure, wireless devices (e.g., UEs 115) may transmit a combination of RF-based measurements and vision-based measurements to a server (e.g., a location server, LMF, or the like) for positioning procedures. In some cases, the combination of RF-based measurements and vision-based measurements may enable the server to calculate (e.g., generate) relatively more accurate positioning estimates and can reduce privacy concerns. In another example, the wireless devices may use the RF-based measurements and vision-based measurements, in combination or separately, to calculate positioning estimates. In accordance with the techniques of the present disclosure, the wireless devices may calculate the positioning estimates using a subset of mapping information for an environment to reduce the power consumption associated with calculating the positioning estimates. Therefore, the techniques of the present disclosure may enable generation of relatively more accurate positioning estimates, reduce the power consumption associated positioning procedures, reduce privacy concerns with positioning procedures using vision-based measurements, or any combination thereof, resulting in an increase in efficiency and reliability of the wireless communications systems 1500.

The following provides an overview of aspects of the present disclosure:

Aspect 1: A method for wireless communications by a wireless device, comprising: outputting, to a server, positioning information associated with the wireless device within an environment, the positioning information being based at least in part on a combination of RF data and visual data, wherein the RF data and the visual data are associated with the environment; and communicating with the server in accordance with the positioning information that is based at least in part on the combination of both the RF data and the visual data.

Aspect 2: The method of aspect 1, wherein outputting the positioning information comprises: outputting, to the server, a request for a positioning estimate of the wireless device, the positioning estimate indicating a location of the wireless device within the environment; and outputting, to the server in conjunction with the request for the positioning estimate, a capability message comprising an indication of one or more sensors associated with the wireless device, information associated with the one or more sensors, or both, wherein the positioning information comprises the request for the positioning estimate and the capability message.

Aspect 3: The method of aspect 2, further comprising: obtaining, from the server, an indication of a configuration for the wireless device to collect and output one or more positioning measurements that comprise a combination of RF-based positioning measurements and visual-based positioning measurements, the configuration being in accordance with capabilities of the wireless device indicated via the capability message; outputting, to the server, the one or more positioning measurements in accordance with the configuration; and obtaining, from the server, the positioning estimate and a confidence score associated with the positioning estimate, the positioning estimate being based at least in part on the one or more positioning measurements.

Aspect 4: The method of aspect 3, wherein communicating with the server in accordance with the positioning information comprises: obtaining, from the server, an indication to adapt the configuration for the wireless device to collect and output the one or more positioning measurements, an indication to adapt a power-saving mode of the wireless device, an indication to disable visual-based data collection, or any combination thereof based at least in part on the positioning estimate, the confidence score of the positioning estimate, or both.

Aspect 5: The method of any of aspects 3 through 4, wherein the one or more positioning measurements are output in accordance with a periodicity.

Aspect 6: The method of any of aspects 1 through 5, further comprising: outputting, to the server, a request for a first subset of mapping information of a set of mapping information associated with the environment in conjunction with outputting the positioning information, the set of mapping information comprising information associated with one or more portions of the environment, wherein the positioning information comprises an indication of a position of the wireless device within the environment that is based at least in part on the combination of the RF data and the visual data; and obtaining, from the server and in response to the request for the first subset of mapping information, an indication of the first subset of mapping information.

Aspect 7: The method of aspect 6, further comprising: outputting, to the server, one or more positioning information reports that are based at least in part on the combination of the RF data and the visual data, the one or more positioning information reports being associated with the first subset of mapping information based at least in part on obtaining the indication of the first subset of mapping information; and obtaining, from the server, an indication of a second subset of mapping information based at least in part on at least one positioning information report of the one or more positioning information reports of the positioning information.

Aspect 8: The method of aspect 7, wherein the at least one positioning information report indicates that the wireless device is at a boundary of a respective portion of the environment of the one or more portions of the environment that is associated with the first subset of mapping information.

Aspect 9: The method of any of aspects 7 through 8, wherein the one or more positioning information reports are output in accordance with a periodicity.

Aspect 10: The method of any of aspects 1 through 9, wherein communicating with the server in accordance with the positioning information comprises: obtaining, from the server, an indication to perform RF-based positioning procedures, to perform visual-based positioning procedures, or both to obtain a respective positioning estimate and a respective confidence score associated with the respective positioning estimate.

Aspect 11: The method of aspect 10, wherein obtaining the indication is based at least in part on whether the respective confidence score associated with the respective positioning estimate satisfies a confidence threshold, an iteration quantity threshold, or both.

Aspect 12: The method of any of aspects 1 through 11, wherein the positioning information is output within a positioning protocol procedure and communications with the server are in accordance with the positioning protocol procedure.

Aspect 13: A method for wireless communications by a wireless device, comprising: outputting, to a server, a request for a first subset of mapping information of a set of mapping information associated with an environment, the set of mapping information comprising information associated with one or more portions of the environment, wherein the request comprises an indication of positioning information associated with the wireless device within the environment; obtaining, from the server and in response to the request, an indication of the first subset of mapping information; outputting, to the server, one or more positioning information reports associated with the first subset of mapping information; and obtaining, from the server, an indication of a second subset of mapping information based at least in part on at least one positioning information report of the one or more positioning information reports.

Aspect 14: The method of aspect 13, wherein the at least one positioning information report indicates that the wireless device is at a boundary of a respective portion of the environment of the one or more portions of the environment that is associated with the first subset of mapping information.

Aspect 15: The method of any of aspects 13 through 14, wherein the one or more positioning information reports are output in accordance with a periodicity.

Aspect 16: The method of any of aspects 13 through 15, wherein positioning information associated with the wireless device within the environment and the one or more positioning information reports are associated with RF data, visual data, or a combination thereof.

Aspect 17: A wireless device for wireless communications, comprising a processing system that includes processor circuitry and memory circuitry that stores code, the processing system configured to cause the wireless device to perform a method of any of aspects 1 through 12.

Aspect 18: A wireless device for wireless communications, comprising at least one means for performing a method of any of aspects 1 through 12.

Aspect 19: A non-transitory computer-readable medium storing code for wireless communications, the code comprising instructions executable by one or more processors to perform a method of any of aspects 1 through 12.

Aspect 20: A wireless device for wireless communications, comprising a processing system that includes processor circuitry and memory circuitry that stores code, the processing system configured to cause the wireless device to perform a method of any of aspects 13 through 16.

Aspect 21: A wireless device for wireless communications, comprising at least one means for performing a method of any of aspects 13 through 16.

Aspect 22: A non-transitory computer-readable medium storing code for wireless communications, the code comprising instructions executable by one or more processors to perform a method of any of aspects 13 through 16.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

The term “communicate” or “communicating” encompasses a variety of interactive processes and, therefore, “communicating” can include obtaining, outputting, transmitting, receiving, conveying, expressing, articulating, disseminating, broadcasting, sharing, and the like. Also, “communicating” can include receiving (e.g., listening to information), interpreting (e.g., decoding messages), perceiving, and the like. Also, “communicating” can include exchanging, dialoguing, corresponding, connecting, engaging, responding, and other such similar actions. Communication may inherently involve the sending of information across various channels and contexts, the receiving of information, or a combination thereof.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A wireless device, comprising:
one or more transceivers;
one or more memory; and
one or more processors electronically coupled with the one or more memory and the one or more transceivers, the one or more processors configured to:
output, to a server, positioning information associated with the wireless device within an environment, the positioning information being based at least in part on a combination of radio frequency data and visual data, wherein the radio frequency data and the visual data are associated with the environment; and
communicate with the server in accordance with the positioning information that is based at least in part on the combination of both the radio frequency data and the visual data.

2. The wireless device of claim 1, wherein, to output the positioning information, the one or more processors are configured to:
output, to the server, a request for a positioning estimate of the wireless device, the positioning estimate indicating a location of the wireless device within the environment; and
output, to the server in conjunction with the request for the positioning estimate, a capability message comprising an indication of one or more sensors associated with the wireless device, information associated with the one or more sensors, or both, wherein the positioning information comprises the request for the positioning estimate and the capability message.

3. The wireless device of claim 2, wherein the one or more processors are further configured to:
obtain, from the server, an indication of a configuration for the wireless device to collect and output one or more positioning measurements that comprise a combination of radio frequency-based positioning measurements and visual-based positioning measurements, the configuration being in accordance with capabilities of the wireless device indicated via the capability message;
output, to the server, the one or more positioning measurements in accordance with the configuration; and
obtain, from the server, the positioning estimate and a confidence score associated with the positioning estimate, the positioning estimate being based at least in part on the one or more positioning measurements.

4. The wireless device of claim 3, wherein, to communicate with the server in accordance with the positioning information, the one or more processors are configured to:
obtain, from the server, an indication to adapt the configuration for the wireless device to collect and output the one or more positioning measurements, an indication to adapt a power-saving mode of the wireless device, an indication to disable visual-based data collection, or any combination thereof based at least in part on the positioning estimate, the confidence score of the positioning estimate, or both.

5. The wireless device of claim 3, wherein the one or more positioning measurements are output in accordance with a periodicity.

6. The wireless device of claim 1, wherein the one or more processors are further configured to:
output, to the server, a request for a first subset of mapping information of a set of mapping information associated with the environment in conjunction with outputting the positioning information, the set of mapping information comprising information associated with one or more portions of the environment, wherein the positioning information comprises an indication of a position of the wireless device within the environment that is based at least in part on the combination of the radio frequency data and the visual data; and
obtain, from the server and in response to the request for the first subset of mapping information, an indication of the first subset of mapping information.

7. The wireless device of claim 6, wherein the one or more processors are further configured to:
output, to the server, one or more positioning information reports that are based at least in part on the combination of the radio frequency data and the visual data, the one or more positioning information reports being associated with the first subset of mapping information based at least in part on obtaining the indication of the first subset of mapping information; and
obtain, from the server, an indication of a second subset of mapping information based at least in part on at least one positioning information report of the one or more positioning information reports of the positioning information.

8. The wireless device of claim 7, wherein the at least one positioning information report indicates that the wireless device is at a boundary of a respective portion of the environment of the one or more portions of the environment that is associated with the first subset of mapping information.

9. The wireless device of claim 7, wherein the one or more positioning information reports are output in accordance with a periodicity.

10. The wireless device of claim 1, wherein, to communicate with the server in accordance with the positioning information, the one or more processors are configured to:
obtain, from the server, an indication to perform radio frequency-based positioning procedures, to perform visual-based positioning procedures, or both to obtain a respective positioning estimate and a respective confidence score associated with the respective positioning estimate.

11. The wireless device of claim 10, wherein obtaining the indication is based at least in part on whether the respective confidence score associated with the respective positioning estimate satisfies a confidence threshold, an iteration quantity threshold, or both.

12. The wireless device of claim 1, wherein the positioning information is output within a positioning protocol procedure and communications with the server are in accordance with the positioning protocol procedure.

13. A wireless device, comprising:
one or more transceivers;
one or more memory; and
one or more processors electronically coupled with the one or more memory and the one or more transceivers, the one or more processors configured to:
output, to a server, a request for a first subset of mapping information of a set of mapping information associated with an environment, the set of mapping information comprising information associated with one or more portions of the environment, wherein the request comprises an indication of positioning information associated with the wireless device within the environment;
obtain, from the server and in response to the request, an indication of the first subset of mapping information;
output, to the server, one or more positioning information reports associated with the first subset of mapping information; and
obtain, from the server, an indication of a second subset of mapping information based at least in part on at least one positioning information report of the one or more positioning information reports.

14. The wireless device of claim 13, wherein the at least one positioning information report indicates that the wireless device is at a boundary of a respective portion of the environment of the one or more portions of the environment that is associated with the first subset of mapping information.

15. The wireless device of claim 13, wherein the one or more positioning information reports are output in accordance with a periodicity.

16. The wireless device of claim 13, wherein positioning information associated with the wireless device within the environment and the one or more positioning information reports are associated with radio frequency data, visual data, or any combination thereof.

17. A method for wireless communications by a wireless device, comprising:
outputting, to a server, positioning information associated with the wireless device within an environment, the positioning information being based at least in part on a combination of radio frequency data and visual data, wherein the radio frequency data and the visual data are associated with the environment; and
communicating with the server in accordance with the positioning information that is based at least in part on the combination of both the radio frequency data and the visual data.

18. The method of claim 17, wherein outputting the positioning information comprises:
outputting, to the server, a request for a positioning estimate of the wireless device, the positioning estimate indicating a location of the wireless device within the environment; and
outputting, to the server in conjunction with the request for the positioning estimate, a capability message comprising an indication of one or more sensors associated with the wireless device, information associated with the one or more sensors, or both, wherein the positioning information comprises the request for the positioning estimate and the capability message.

19. The method of claim 17, wherein communicating with the server in accordance with the positioning information comprises:
obtaining, from the server, an indication to perform radio frequency-based positioning procedures, to perform visual-based positioning procedures, or both to obtain a respective positioning estimate and a respective confidence score associated with the respective positioning estimate.

20. The method of claim 17, wherein the positioning information is output within a positioning protocol procedure and communications with the server are in accordance with the positioning protocol procedure.
